(19) United States
(12) Patent Application Publication
(10) Pub. No.: US 2012/0294454 A1
(43) Pub. Date: Nov. 22, 2012

(54) MOBILE TERMINAL AND EARPHONE IDENTIFYING METHOD

(75) Inventors: Yasuyuki SAKAMOTO, Osaka (JP); Yoshiomi KUSUNOKI, Osaka (JP)

(73) Assignee: KYOCERA CORPORATION, Kyoto (JP)

(21) Appl. No.: 13/475,977

(22) Filed: May 19, 2012

(30) Foreign Application Priority Data
May 20, 2011 (JP) 2011-113858
Aug. 26, 2011 (JP) 2011-184236
Feb. 15, 2012 (JP) 2012-030255

(51) Int. Cl. H04R 1/10; H04B 3/20

(52) U.S. Cl. 381/66; 381/384

(57) ABSTRACT

A mobile phone apparatus 10 is provided with a five conductor earphone jack 26, etc. which is used to be shared between four and five conductor earphone plugs. Also, the two plugs have a left audio terminal at the same position, but a right audio terminal and a GND terminal at opposite positions. When the earphone plug is inserted, a tone signal is output from a third jack terminal. At this time, if the four conductor earphone plug is inserted, a tone signal is output as a leakage signal from a first jack terminal through a four conductor earphone. Then, the leakage signal is amplified, and input to a controlling circuit (70). On the other hand, if the five conductor earphone plug is inserted, a leakage signal is not output.

### CROSS REFERENCE OF RELATED APPLICATION

The disclosure of Japanese Patent Application No. 2011-113858, No. 2011-184236, and No. 2012-30255 are incorporated herein by reference.

### BACKGROUND OF THE INVENTION

1. Field of the Invention

The present invention relates to a portable terminal and an earphone identifying method. Specifically, the present invention relates to a portable terminal and an earphone identifying method capable of outputting a sound by utilizing earphones.

2. Description of the Related Art

Mobile terminals capable of outputting sounds through earphones have been widely known, and one example of such apparatuses is disclosed in a Japanese Patent 4526571 [H04M 1/00, H04M 1/02, H04M 1/05] registered in Jun. 11, 2010. The mobile phone apparatus of the related art has an earphone microphone terminal to which an earphone microphone or a PTT earphone microphone that are different in the number of terminals are to be connected.

However, in the mobile phone apparatus of the related art, the earphone microphone terminal needs seven contacts in order to determine which is connected, the earphone microphone or the PTT earphone microphone that are different in the number of terminals.

### SUMMARY OF THE INVENTION

Therefore, it is a primary object of the present invention to provide a novel portable terminal and earphone identifying method.

Another object of the present invention is to provide a portable terminal and an earphone identifying method capable of suitably utilizing earphones being different in the number of terminals.

The present invention employs following features in order to solve the above-described problem. It should be noted that reference numerals and the supplements inside the parentheses show one example of a corresponding relationship with the embodiments described later for easy understanding of the present invention, and do not limit the present invention.

A first aspect of the present invention is a mobile terminal having a five conductor earphone jack used to be shared between a five conductor earphone plug provided with a left audio terminal, a right audio terminal and a GND terminal and a four conductor earphone plug provided with a left audio terminal provided at an equal position to the five conductor earphone and a GND terminal and a right audio terminal provided at positions opposite to those of the five conductor earphone plug, the five conductor earphone jack including a first terminal to be in contact with the right audio terminal of the five conductor earphone plug or the GND terminal of the four conductor earphone plug and a second terminal to be in contact with the left audio terminal, comprising an outputter which outputs a test signal to the second terminal when the four conductor earphone plug or the five conductor earphone plug is inserted into the five conductor earphone jack, and an identifier which identifies which earphone plug is inserted, the five conductor earphone plug or the four conductor earphone plug depending on a detection of the test signal at the first terminal when the test signal is output from the outputter.

A second aspect of the present embodiment is an earphone identifying method of a mobile terminal (10) having a five conductor earphone jack (26) used to be shared between a five conductor earphone plug provided with a left audio terminal, a right audio terminal and a GND terminal and a four conductor earphone plug provided with a left audio terminal provided at an equal position to the five conductor earphone and a GND terminal and a right audio terminal provided at positions opposite to those of the five conductor earphone plug, the five conductor earphone jack including a first terminal (first jack terminal) to be in contact with the right audio terminal of the five conductor earphone plug or the GND terminal of the four conductor earphone plug and a second terminal (third jack terminal) to be in contact with the left audio terminal, and including an outputter (96) outputting a test signal to the second terminal when the four conductor earphone plug or the five conductor earphone plug is inserted into the five conductor earphone jack, comprising identifying which is inserted, the five conductor earphone plug or the four conductor earphone plug depending on a detection of the test signal at the first terminal when the test signal is output from the outputter (S19-S25).

A third aspect of the present invention is a mobile terminal having an earphone jack used to be shared between a four conductor earphone plug provided with a left audio terminal, a right audio terminal and a GND terminal and a five conductor earphone plug provided with a left audio terminal provided at an equal position to the four conductor earphone and a GND terminal and a right audio terminal provided at positions opposite to those of the four conductor earphone plug, the earphone jack including a first terminal to be in contact with the left audio terminal, a second terminal to be in contact with the GND terminal of the five conductor earphone plug or the right audio terminal of the four conductor earphone plug, and a third terminal to be in contact with the right audio terminal of the five conductor earphone plug or the GND terminal of the four conductor earphone plug, comprising: a voltage applier which applies a voltage to the first terminal when the earphone plug is inserted into the earphone jack; a detector which detects a voltage of the third terminal when the voltage applier applies the voltage; a first judger which judges that the five conductor earphone plug is inserted into the earphone jack when the detector detects no voltage after the voltage is applied; a second judger which judges that the four conductor earphone plug is inserted into the earphone jack when the detector detects a voltage after the voltage is applied; and a switcher which makes a switch to a position causing the right audio signal to be output to the third terminal and causing the second terminal to be grounded when the first judger judges that the five conductor earphone plug is inserted, and makes a switch to a position causing the third terminal to be grounded and causing the right audio signal to be output to the second terminal when the second judger judges that the four conductor earphone plug is inserted.

A fourth aspect of the present invention is a mobile terminal (10) to which a first earphone plug (five conductor earphone plug) and a second earphone plug (four conductor earphone plug) provided with GND terminals and first audio terminals at opposite positions between them can be inserted, comprising a measure which measures a voltage of a jack of the first audio terminal when the first earphone plug and the second earphone plug are inserted (75); and a switcher which switches the GND terminal and a signal to be output to the first audio terminal on the basis of a result of the measurement by the measure (73).

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing an electric configuration of a mobile phone of one embodiment of the present invention.

FIG. 2 is an illustrative view showing one example of an appearance of a five conductor earphone plug to be inserted into an earphone jack shown in FIG. 1.

FIG. 3 is an illustrative view showing one example of an appearance of a four conductor earphone plug to be inserted into the earphone jack shown in FIG. 1.

FIG. 4 is an illustrative view showing one example of an electric configuration around the processor and the earphone jack shown in FIG. 1.

FIG. 5 is an illustrative view showing one example of an electrical connection when the five conductor earphone plug is inserted into the earphone jack shown in FIG. 1.

FIG. 6 is an illustrative view showing one example of an electrical connection when the four conductor earphone plug is inserted into the earphone jack shown in FIG. 1.

FIG. 7 is an illustrative view showing another example of an electrical connection when the four conductor earphone plug is inserted into the earphone jack shown in FIG. 1.

FIG. 8 is an illustrative view showing one example of waveforms of a signal amplified by a first amplifying circuit and a second amplifying circuit shown in FIG. 4.

FIG. 9 is an illustrative view showing another example of an electrical connection when the five conductor earphone plug is inserted into the earphone jack shown in FIG. 1.

FIG. 10 is an illustrative view showing one example of a cross section of the earphone jack with the five conductor earphone plug shown in FIG. 2 inserted into the earphone jack.

FIG. 11 is an illustrative view showing one example of an electrical connection with the five conductor earphone plug inserted into the earphone jack shown in FIG. 10.

FIG. 12 is an illustrative view showing one example of a memory map of a RAM shown in FIG. 1.

FIG. 13 is a flowchart showing one example of identification processing by the processor shown in FIG. 1.

FIG. 14 is an illustrative view showing another example of an electric configuration around the processor and the earphone jack shown in FIG. 1.

FIG. 15 is a flowchart showing another example of identification processing by the processor shown in FIG. 1.

FIG. 16 is an illustrative view showing an electric configuration of a mobile phone of another embodiment of the present invention.

FIG. 17 is an illustrative view showing another example of an electric configuration of the earphone jack shown in FIG. 16.

FIG. 18 is an illustrative view showing a circuit with the earphone plug inserted into the earphone jack shown in FIG. 17.

FIG. 19 is an illustrative view showing another example of a memory map of a RAM shown in FIG. 16.

FIG. 20 is a flowchart showing one example of judgment processing by the processor shown in FIG. 16.

### DETAILED DESCRIPTION OF THE PREFERRED EMBODIMENTS

### First Embodiment

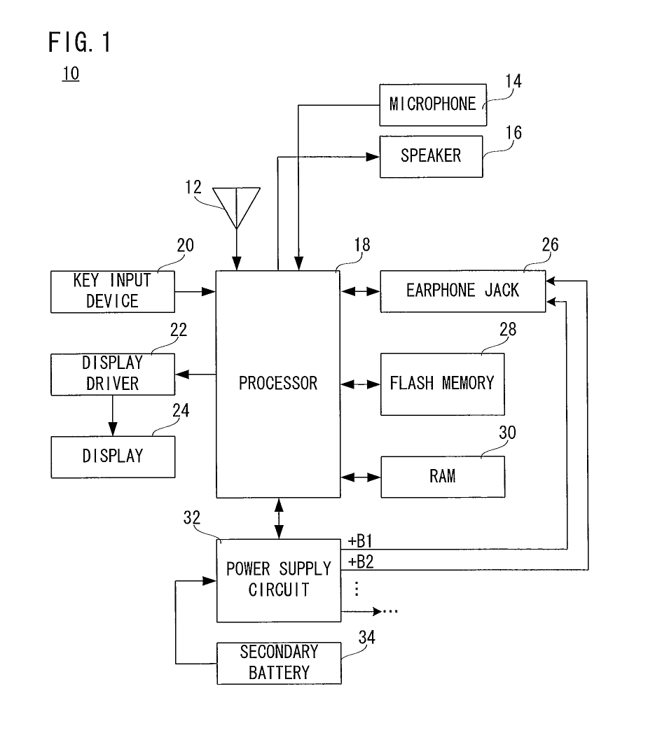

Referring to FIG. 1, a mobile phone apparatus 10 is a type of mobile terminals and includes a processor 18. Also, the processor 18 is connected with an antenna 12, a microphone 14, a speaker 16, a key input device 20, a display driver 22, an earphone jack 26, a flash memory 28, a RAM 30, a power supply circuit 32, etc.

Furthermore, the display driver 22 is connected to a display 24. Then, the power supply circuit 32 is connected to a secondary battery 34, etc. Here, the earphone jack 26 can also be connected to the power supply circuit 32.

The processor 18 is called a computer or a baseband chip, and includes a plurality of circuits for totally controlling the mobile phone apparatus 10. The RAM 30 is utilized as a work area (including a depiction area) or a buffer area of the processor 18. In the flash memory 28, content data such as characters, images, sounds, and video images of the mobile phone apparatus 10 is recorded.

An analog audio signal as to a sound or a tone input through the microphone 14 is input to the processor 18. Furthermore, in the processor 18, a digital audio signal is converted into an analog audio signal, and sound or tone corresponding to the analog audio signal is output from the speaker 16.

The key input device 20 is called an operating portion, and includes an off-hook key, a function key, an on-hook key, etc. Furthermore, key information (key data) operated by the user is input to the processor 18. In addition, in a case that a PTT (Push To Talk) function described later is executed, the function key is used as a PTT switch. The display driver 22 controls displaying of the display 24 under the control of the processor 18. Also, the display driver 22 includes a video memory for temporarily storing image data to be displayed.

Furthermore, the display 24 is provided with a backlight whose light source is an LED. In addition, the backlight is provided to the display panel included in the display 24 based on an edge light system. As a light source of the backlight, an LED may be adopted, but in another embodiment, a cold cathode, etc. may be adopted.

The power supply circuit 32 is an IC for managing a power source, and the power supply circuit 32 supplies power based on the voltage of the secondary battery 34 to the total system. Here, a state that electric power is supplied to the total system by the power supply circuit 32 is referred to as a “power-on state”. On the other hand, a state that electric power is not supplied to the total system by the power supply circuit 32 is referred to as a power-off state. When a power-on operation is performed by the key input device 20 in the power-off state, the power supply circuit 32 is activated, and when a power-off operation is performed by the key input device 20 in the power-on state, the power supply circuit 32 is suspended. In addition, even in the power-off state, when an external power source is connected to a connector for external charge not shown of the power supply circuit 32 to deliver electric power (recharge) to the secondary battery 34, the power supply circuit 32 is activated, and when a fully-charged state of the secondary battery 34 is detected, the power supply circuit 32 is suspended. Here, “recharging” means that the external power source is connected to the connector for external charge to cause the secondary battery 34 to store electric energy.

Here, the power supply circuit 32 has two ports such as a +B1 port outputting electric power at 2.6 V and a +B2 port outputting electric power at 1.8 V. Then, the above-described two ports are connected to the earphone jack 26.

The five conductor earphone jack 26 is a female terminal, and a plug of an earphone (earphone plug) being a male terminal is inserted thereinto. Thus, when the earphone plug is inserted into the five conductor earphone jack 26, an insertion signal indicative of insertion or removal changes. Then, when the processor 18 determines that the earphone plug is inserted based on a change of the insertion signal, a switch (SW2, SW3) makes a selection such that a sound or a tone corresponding to the analog audio signal is output from a speaker of the earphone (hereinafter, referred to as earpieces). Here, when an earphone plug of an earphone having a microphone is inserted, a switch (SW4) makes a selection such that a sound is obtained by the microphone of the earphone (hereinafter, referred to as an earphone microphone).

Then, the earphone jack 26 is also called a five conductor earphone jack, and has a shape to which a five-conductor PTT earphone including right and left earpieces, an earphone microphone, and a switch can be inserted. Here, into the earphone jack 26, a four-conductor handsfree earphone including right and left earpieces, an earphone microphone, and a switch can also be inserted. That is, the earphone jack 26 of this embodiment is used to be sharable among earphone plugs of the PTT earphone complying with requirements specifications of makers, etc. and earphone plugs of the handsfree earphone for mobile phone apparatus that are available more in the markets.

Hereafter, a switch belonging to the PTT earphone is called a “PTT switch”, and a switch belonging to the handsfree earphone is called an “earphone switch”. Also, the PTT earphone may be referred to as a “five conductor earphone”, and the handsfree earphone may be referred to as a “four conductor earphone”.

Furthermore, the shapes of a five conductor earphone plug and a four conductor earphone plug are described later, and therefore, the detailed description is omitted here.

The mobile phone apparatus 10 complies with the above-described PTT function. The PTT function is a function of establishing a half-duplex communication with another terminal and making an alternate speech communication with a communication partner. When the PTT function is executed in the mobile phone apparatus 10 of this embodiment, and a group including a plurality of mobile phone apparatuses is set, each mobile phone apparatus in this group establishes a half-duplex communication with the other mobile phone apparatuses. While no one transmits voice, when a user of a certain mobile phone apparatus turns the PTT switch on, the user can transmits a voice to the rest of all the mobile phone apparatuses. Furthermore, when the PTT switch is turned off, a voice transmitted from another mobile phone apparatus can be received. That is, while the PTT function is being executed, the user makes a switch between a voice transmitting state and a voice receiving state by selecting the PTT switch between ON and OFF.

For example, while the PTT function is executed, in a case that the PTT earphone is utilized, the user can listen to the received voice by right and left earpieces, and make a switch between the voice transmitting state and the voice receiving state by operating the PTT switch.

Furthermore, while the PTT function is being executed, even if the handsfree earphone is used as well, the user can listen to the received voice, and input a voice by using the handsfree earphone. Then, the user can make a switch between the voice transmitting state and the voice receiving state by operating the PTT switch included in the key input device 20.

In addition, while the PTT function is being executed, even if each earphone is not used, the user can listen to the received voice by using the speaker 16 of the mobile phone apparatus 10 and input voice by using the microphone 14. In this case as well, the user can make a switch between the voice transmitting state and the voice receiving state by operating the PTT switch included in the key input device 20.

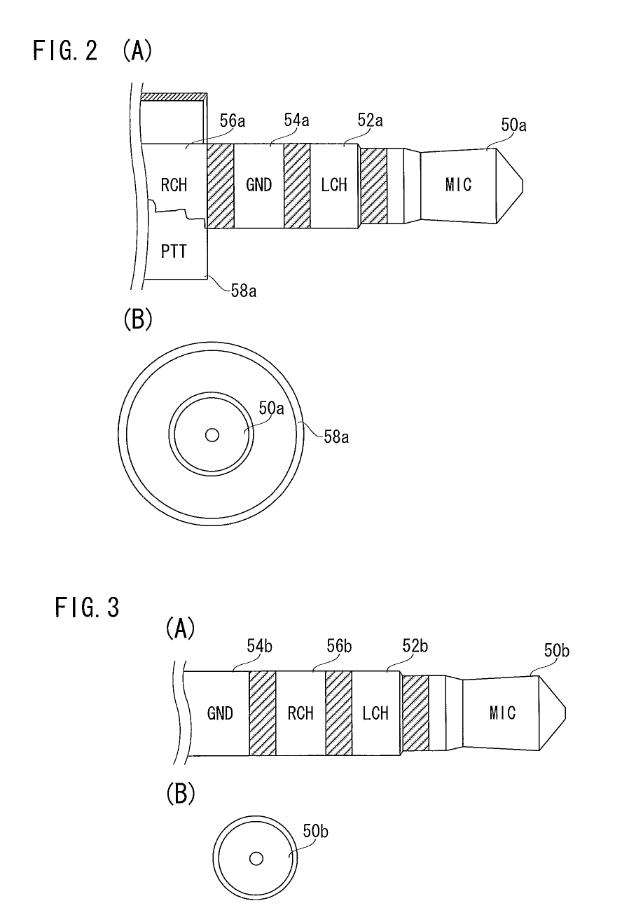

FIG. 2(A) is an illustrative view showing an appearance of the five conductor earphone plug as seen from a side, and FIG. 2(B) is an illustrative view showing an appearance of the five conductor earphone plug as seen from the tip end. With reference to FIG. 2(A), to the five conductor earphone plug, a microphone terminal 50a, a left audio terminal 52a, a GND terminal 54a and a right audio terminal 56a are provided from the tip end side. As understood from FIG. 2(A), (B), to the five conductor earphone plug, a switch terminal 58a is further provided so as to cover the right audio terminal 56a. Then, the microphone terminal 50a, the left audio terminal 52a, the GND terminal 54a and the right audio terminal 56a are insulated by insulators (shown by slanted lines in the drawing).

The microphone terminal 50a is connected to the earphone microphone of the PTT earphone, and the left audio terminal 52a is connected to the left earpiece, the right audio terminal 56a is connected to the right earpiece, and the switch terminal 58a is connected to the PTT switch. In addition, the GND terminal 54a is connected to a GND of the mobile phone apparatus 10 when being inserted into the earphone jack 26.

FIG. 3(A) is an illustrative view showing an appearance of the four conductor earphone plug as seen from a side, and FIG. 3(B) is an illustrative view showing an appearance of the four conductor earphone plug as seen from the tip end. With reference to FIG. 3(A), to the four conductor earphone plug, a microphone terminal 50b, a left audio terminal 52b, a right audio terminal 56b and a GND terminal 54b are provided from the tip end side. Furthermore, as understood from FIG. 3(A) and FIG. 3(B), the four conductor earphone plug is not provided with the switch terminal 58a unlikely to the five conductor earphone plug. Then, each terminal of the four conductor earphone plug is insulated by insulators similar to the five conductor earphone plug.

The microphone terminal 50b is connected to the earphone microphone and the earphone switch of the handsfree earphone, the left audio terminal 52b is connected to the left earpiece, and the right audio terminal 56b is connected to the right earpiece. In addition, the GND terminal 54b is connected to the GND of the mobile phone apparatus 10 when being inserted into the earphone jack 26.

It should be noted that in a case that each terminal need not be discriminated between the five conductor earphone plug and the four conductor earphone plug, subscripts of the alphabetical characters are omitted.

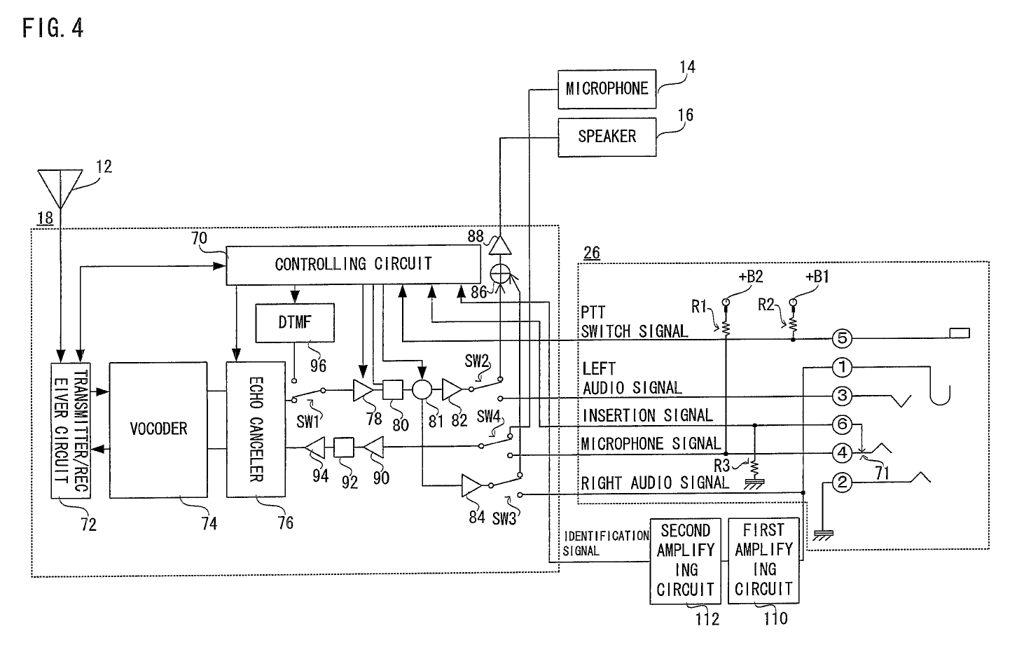

FIG. 4 is an illustrative view showing an electric configuration around the processor 18 and the earphone jack 26. Referring to FIG. 4, the processor 18 includes a controlling circuit 70, a transmitter/receiver circuit 72, a VOCORDER 74, an echo canceler 76, a DTMF (Dual Tone Multi Frequency) generator 96, etc. Furthermore, the controlling circuit 70 is connected with the transmitter/receiver circuit 72, the echo canceler 76, the DTMF generator 96, etc. The transmitter/receiver circuit 72 is connected to the antenna 12 inside the processor 18, and its transmission path and its reception path are connected to the echo canceler 76 via the VOCODER 74.

In the reception path, the echo canceler 76 is connected to a D/A converter 80 via a switch SW1 and a first digital gain 78. Furthermore, the D/A converter 80 is connected to an adder 86 through a selector 81, a first analog amplifier 82 and a switch SW2 in a path for left audio signal, and is connected to the adder 86 through the selector 81, a second analog amplifier 84 and a switch SW3 in a path for right audio signal. Then, the adder 86 is connected to the speaker 16 through a third analog amplifier 88.

On the other hand, in the transmission path, a switch SW4, a fourth analog amplifier 90, an A/D converter 92 and a second digital gain 94 are connected from the side of the microphone 14 between the microphone 14 and the echo canceler 76.

The transmitter/receiver circuit 72 is a circuit for making a wireless communication in a CDMA system. For example, when the user commands phone transmission (outgoing call) by using the key input device 20, the transmitter/receiver circuit 72 executes phone transmission processing under the control of the controlling circuit 70, and outputs a phone transmission signal via the antenna 12. The phone transmission signal is transmitted to the telephone of the communication partner through the base stations and a communication network (not illustrated). Then, when incoming call processing is performed in the telephone of the communication partner, a communication capable state is established, and the controlling circuit 70 executes speech communication processing.

Describing a normal speech communication processing in detail, a modulated audio signal transmitted from the telephone of the communication partner is received by the antenna 12. The received modulated audio signal undergoes demodulation processing by the transmitter/receiver circuit 72 and decoding processing by the VOCODER 74. Furthermore, the received audio signal obtained by such processing is amplified by the first digital gain 78, and the amplified signal is converted into an analog audio signal by the first D/A converter 80. Here, the controlling circuit 70 controls the selector 81 to output the converted analog audio signal to the right and left audio signal paths. That is, the converted analog audio signals are amplified by the first analog amplifier 82 and the second analog amplifier 84, and the two analog audio signals are added by the adder 86. Then, the added analog audio signal is amplified by the third analog amplifier 88 and applied to the speaker 16. Therefore, the received voice signal or the sound corresponding to the analog audio signal is output from the speaker 16.

On the other hand, a voice signal to be transmitted taken through the microphone 14 is amplified by the fourth analog amplifier 90 after the switch SW4. The amplified signal is converted into a digital audio signal by the A/D converter 92, and is then further amplified by the second digital gain 94. Moreover, a noise component called “echo” of the amplified digital audio signal is removed by the echo canceler 76. It should be noted that the “echo” is a noise occurring in the voice signal to be transmitted due to the fact that the microphone 14 may obtain the received voice signal, for example.

Then, the digital audio signal from which the echo is removed undergoes encoding processing by the VOCODER 74, and the encoded signal undergoes modulation processing by the transmitter/receiver circuit 72 and output via the antenna 12. Thus, the modulated audio signal is transmitted to the telephone of the communication partner via base stations and the communication network.

In addition, when a phone transmission signal from the telephone of the communication partner is received by the antenna 12, the transmitter/receiver circuit 72 notifies phone reception (incoming call) of the controlling circuit 70. Corresponding thereto, the processor 18 (controlling circuit 70) controls the display driver 22 to display calling source information (phone number, etc.) described in the incoming call notification on the display 24. Approximately the same time, the controlling circuit 70 also outputs an incoming call tone (sometimes referred to be incoming call melody, ring tone) from the speaker 16.

Then, when the user performs an answer operation by using the off-hook key, the transmitter/receiver circuit 72 executes phone reception (incoming call) processing under the control of the controlling circuit 70. In addition, when a communication capable state is established, the controlling circuit 70 executes the above-described normal speech communication processing.

Furthermore, after a transition to the speech communication allowable state, when a speech communication end operation is performed by the on-hook key, the controlling circuit 70 controls the transmitter/receiver circuit 72 to transmit a speech communication end signal to the communication partner. Then, after transmission of the speech communication end signal, the controlling circuit 70 ends the speech communication processing. Or, when a speech communication end signal is received from the communication partner as well, the controlling circuit 70 ends the speech communication processing. In addition, if a speech communication end signal is received from the mobile communication network irrespective of the communication partner as well, the controlling circuit 70 ends the speech communication processing.

Here, if a signal indicating that the communication partner is in the middle of a phone call, the controlling circuit 70 switches the switch SW1, and issues an instruction of outputting a tone signal to the DTMF generator 96 being an outputting unit to thereby output a tone signal from the speaker 16.

Next, the earphone jack 26 includes a first jack terminal (first terminal) to be in contact with the right audio terminal 56a of the five conductor earphone plug or the GND terminal 54b of the four conductor earphone plug, a second jack terminal (third terminal) to be in contact with the GND terminal 54a of the five conductor earphone plug or the right audio terminal 56b of the four conductor earphone plug, a third jack terminal (second terminal) to be in contact with the left audio terminal 52, a fourth jack terminal to be in contact with the microphone terminal 50, a fifth jack terminal to be in contact with the switch terminal 58a of the five conductor earphone plug, and a sixth jack terminal to be in contact with the fourth jack terminal inside the earphone jack 26.

The first jack terminal receives an input of a right audio signal, and is connected to the switch SW3 of the processor 18. Also, between the first jack terminal and the switch SW3, a first amplifying circuit 110 is connected. The first amplifying circuit 110 is connected to the second amplifying circuit 112, and the output of the second amplifying circuit 112 is input to the controlling circuit 70 as an identification signal. Here, the first amplifying circuit 110 and the second amplifying circuit 112 may sometimes be both referred to as an amplifying unit. Furthermore, the amplifying unit will be described later, and the detailed description thereof is omitted here.

The second jack terminal is grounded. Furthermore, the third jack terminal receives an input of a left audio signal, and is connected to the switch SW2 of the processor 18.

The fourth jack terminal is connected to the switch SW4. Between the fourth jack terminal and the switch SW4, the +B2 port of the power supply circuit 32 is connected through a resistor R1. Furthermore, the fourth jack terminal receives an input of a microphone signal relative to a sound or tone input through the microphone of the PTT earphone or the handsfree earphone.

The fifth jack terminal is connected to the controlling circuit 70 of the processor 18. Between the fifth jack terminal and the controlling circuit 70, the +B1 port of the power supply circuit 32 is connected through a resistor R2. Then, the voltage value to be applied to the fifth jack terminal varies depending on the ON-OFF states of the PTT switch, and the voltage value is used as a PTT switch signal.

The sixth jack terminal is connected to the controlling circuit 70 of the processor 18. Furthermore, between the sixth jack terminal and the controlling circuit 70, a GND is connected through a resistor R3. In addition, the sixth jack terminal is in contact with the fourth jack terminal at a contact 71 as described above with the earphone plug not inserted, and the sixth jack terminal is separated from the fourth jack terminal with the earphone plug inserted. Then, the fourth jack terminal is connected with the +B2 port, and thus, if the contact 71 is in contact with the fourth jack terminal, a voltage is applied to the sixth jack terminal. On the other hand, if the contact 71 is not in contact with the fourth jack terminal, no voltage is applied to the sixth jack terminal. Thus, the voltage value of the sixth jack terminal is utilized as an insertion signal indicating an insertion or a removal of the earphone plug.

For example, if the earphone plug is not inserted, a voltage is applied to the sixth jack terminal, so that the insertion signal goes “H (high)” to make the controlling circuit 70 determine that the earphone plug is not inserted. On the other hand, if the earphone plug is inserted, no voltage is applied to the sixth jack terminal, so that the insertion signal goes “L (Low)” to make the controlling circuit 70 determine that the earphone plug is inserted.

Here, when the earphone plug is inserted into the earphone jack 26 to make the detection signal go low “L”, each of the switches SW2, SW3, SW4 is switched. Thus, the first analog amplifier 82 is connected to the third jack terminal of the earphone jack 26 in place of the adder 86. Furthermore, the second analog amplifier 84 is connected to the first jack terminal of the earphone jack 26 in place of the adder 86. In addition, the fourth analog amplifier 90 is connected to the fourth jack terminal of the earphone jack in place of the microphone 14.

As a result, a left audio signal to be output from the speaker 16 is output from the earpiece connected to the third jack terminal. Furthermore, a right audio signal to be output to the speaker 16 is output from the earpiece connected to the first jack terminal. Then, ambient sound acquired by the microphone 14 is acquired by the earphone microphone connected to the fourth jack terminal.

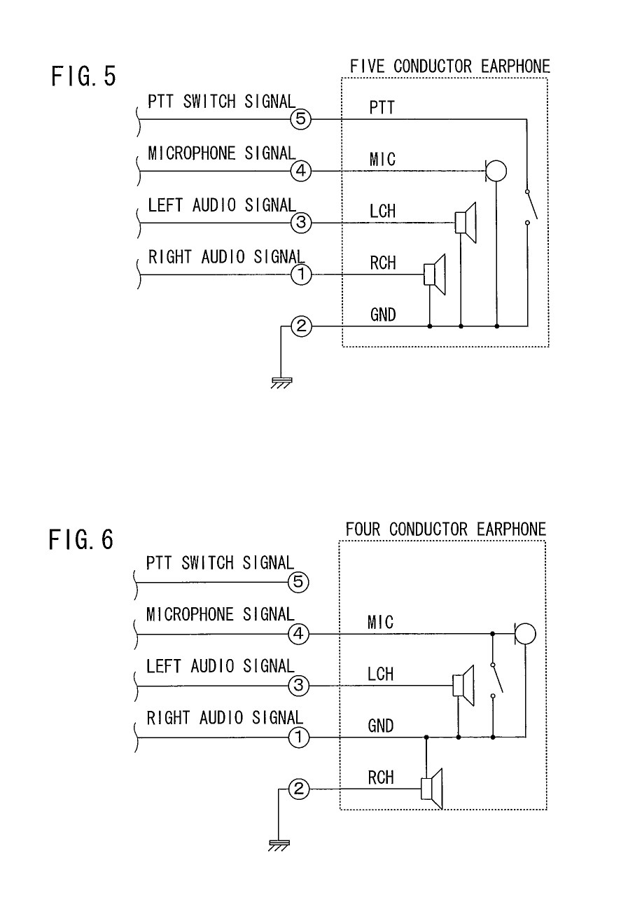

FIG. 5 is an illustrative view showing one example of an electric connection when the five conductor earphone plug is inserted into the five conductor earphone jack 26. With reference to FIG. 5, the first jack terminal to output a right audio signal is connected with the right audio terminal 56a connected to the right earpiece (Rch). The grounded second jack terminal is connected with the GND terminal 54a of the five conductor earphone plug. The third jack terminal to output a left audio signal is connected with the left audio terminal 52a connected to the left earpiece (Lch). The fourth jack terminal which receives an input of a microphone signal is connected with the microphone terminal 50a connected to the earphone microphone (Mic). The fifth jack terminal which receives an input of a PTT switch signal is connected with the switch terminal 58a connected to the PTT switch.

FIG. 6 is an illustrative view showing one example of an electrical connection when the four conductor earphone plug is inserted into the five conductor earphone jack 26. With reference to FIG. 6, the first jack terminal to output a right audio signal is connected with the GND terminal 54b of the four conductor earphone plug. The grounded second jack terminal is connected with the right audio terminal 56b connected to the right earpiece (Rch). The third jack terminal to output a left audio signal is connected with the left audio terminal 52b connected to the left earpiece (Lch). The fourth jack terminal which receives an input of a microphone signal is connected with the microphone terminal 50b connected to the earphone microphone (Mic). Here, the four conductor earphone does not have the PTT terminal 58, so that the fifth jack terminal is connected with nothing.

It should be noted that in FIG. 5 and FIG. 6, illustration of the sixth jack terminal to output a detection signal is omitted.

Here, as shown in FIG. 2 (A) and FIG. 3(A), the positions of the GND terminal 54b and the right audio terminal 56b of the four conductor earphone plug are opposite to the positions of those of the five conductor earphone plug. Thus, as understood from FIG. 5 and FIG. 6, the terminals of the earphone plugs to be connected to the first jack terminal and the second jack terminal are interchanged between when the five conductor earphone plug is inserted into the five conductor earphone jack 26 and when the four conductor earphone plug is inserted thereinto.

For example, in a case that a speech communication is made by the PTT function, the received voice signal is output from the first jack terminal and the third jack terminal as a monophonic sound, and thus, the same sounds are output from the right and left earpieces. However, in a case that the four conductor earphone plug is inserted into the five conductor earphone jack 26, when a speech communication is made by the PTT function, the monophonic signal approximately in phase and in the same level is input across the left earpiece of the four conductor earphone. In this case, a voltage difference is not created across the left earpiece, so that sound output of the left earpiece is extremely low. On the other hand, a right audio signal output from the first jack terminal is applied to the right earpiece in a single end form, so that sound is output at an adequate volume. Accordingly, in a case that the four conductor earphone is used, a difference in volume arises between the right and left earpieces.

Also, the right audio signal (monophonic signal) is input to the GND of the four conductor earphone without being connected to grounded second jack terminal. Thus, the right audio signal unintentionally flows into to the earphone microphone as a leakage signal, so that the leakage signal is input to the fourth jack terminal. As a result, the leakage signal (right audio signal) input to the fourth jack terminal may be transmitted to the communication partner as an echo.

In order to address these problems, two measures can be considered; one is to short out the first jack terminal and the second jack terminal to be grounded, and the other is to fix the echo canceler 76 to a state when the four conductor earphone plug is inserted. If these measures are taken, whichever of the four conductor earphone plug or the five conductor earphone plug is inserted, a sound is output from the side of the left earpiece, and the leakage signal does not unintentionally flow through the earphone microphone. Furthermore, double talk performance slightly degrades by the echo canceler 76, but irrespective of the kind of the used earphone, predetermined speech quality can be maintained.

However, in a case these measures are taken, even if the five conductor earphone plug corresponding to the requested specification is inserted, sound is not output from the right earpiece. Furthermore, although it is not necessary to degrade the double talk performance by the echo canceler 76 when the five conductor earphone is used, the double talk performance must be degraded when the five conductor earphone is used as well.

Hereupon, in the first embodiment, the aforementioned drawbacks are overcome by identifying the kind of the earphone plug inserted into the earphone jack 26, and working as a four conductor earphone mode when the four conductor earphone plug is inserted into the earphone jack 26.

First, a method of identifying the kind of the inserted earphone plug is described. When detecting the insertion of the earphone plug based on the changes of the state of the insertion signal, the controlling circuit 70 switches the switch SW1 to the side of the DTMF generator 96, and switches the switch SW2 to the side of the third jack terminal. Also, after switching the switches SW1, SW2, the controlling circuit 70 controls the DTMF generator 96 to output a tone signal (test signal) of 400 Hz/90 mVp-p for a predetermined time period (100 ms, for example). The output tone signal is input to the third jack terminal, and in a case that the four conductor earphone plug is inserted, due to the loop of the tone signal, a leakage signal is detected in the first jack terminal. On the other hand, in a case that the five conductor earphone plug is inserted, due to the absence of the loop of the tone signal, a leakage signal is not detected in the first jack terminal. Thus, in this embodiment, the presence or absence of the leakage signal in the first jack terminal is utilized to identify the kind of the earphone plug.

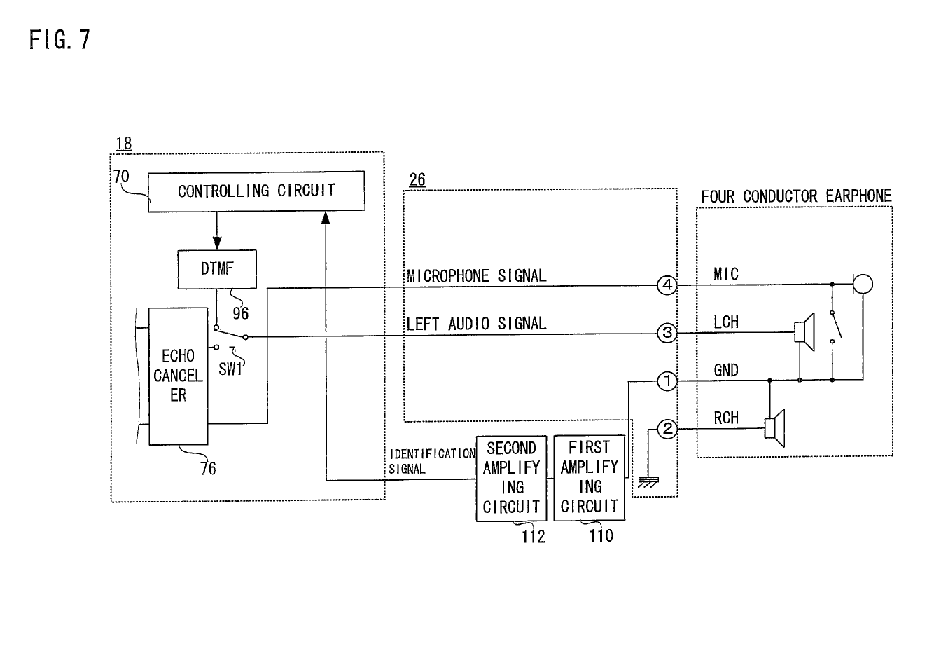

FIG. 7 is an illustrative view showing an electrical connection with the four conductor earphone plug inserted into the earphone jack 26. Here, unnecessary circuit components, etc. are omitted in FIG. 7. Referring to FIG. 7, after switching by the switch SW1, the tone signal output from the DTMF generator 96 is input from the third jack terminal to the left earpiece (Lch). At this time, a loop of the tone signal occurs, and a leakage signal having a signal level about half (45 mVp-p) the signal level of the tone signal flows into the first jack terminal.

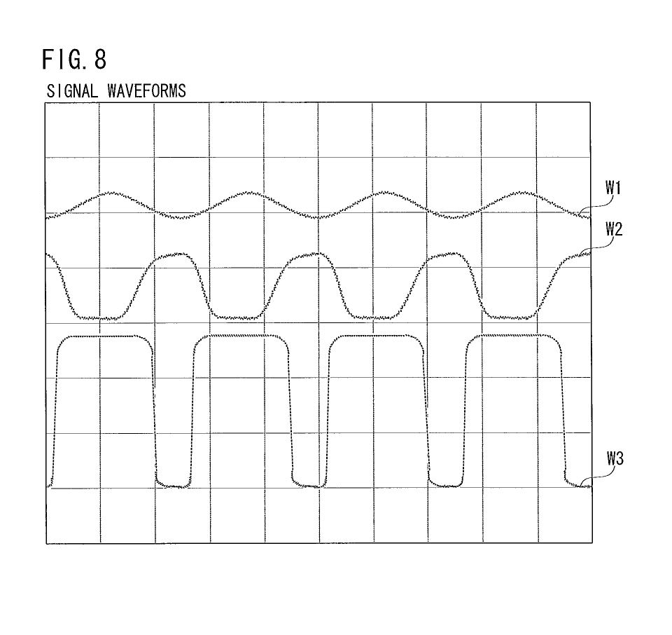

With reference to FIG. 8, the waveform of the above-described leakage signal is shown by the waveform W1. Then, the leakage signal is amplified into the waveform W2 by the first amplifying circuit 110, and further amplified into the waveform W3 by the second amplifying circuit 112. That is, the leakage signal being a sine wave is amplified by the first amplifying circuit 110 and the second amplifying circuit 112 into a pulse signal that alternates between “H” and “L” at 400 Hz. Furthermore, the amplified pulse signal is input to an interruption signal detecting port of the controlling circuit 70 as an identification signal. Then, detecting the change of the identification signal alternating between “H” and “L” by the predetermined number of times (3 times, for example), the controlling circuit 70 identifies the insertion of the four conductor earphone plug. The advantage of utilizing the pulse signal is described later and thus omitted here. It should be noted that the predetermined number of times may be less than three times or be equal to or more than four times.

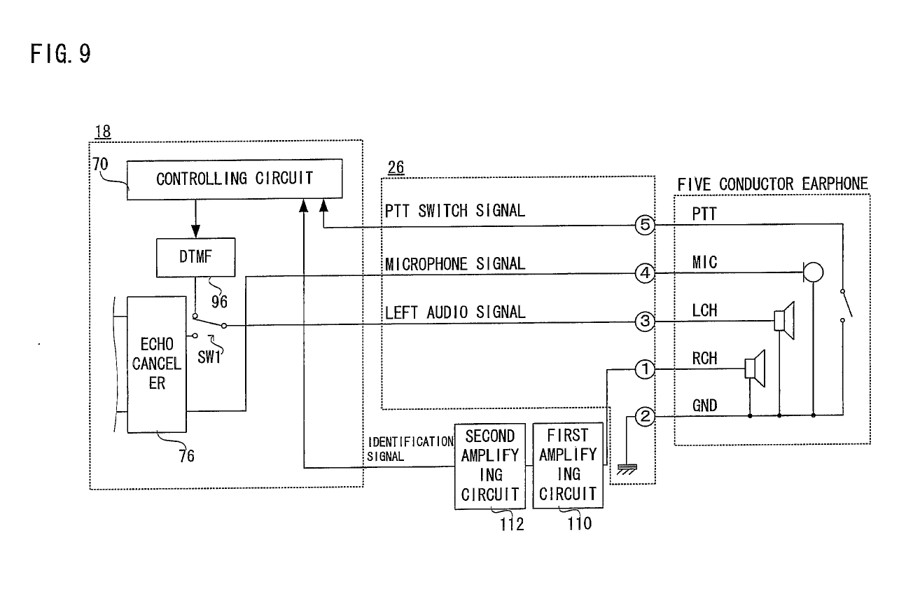

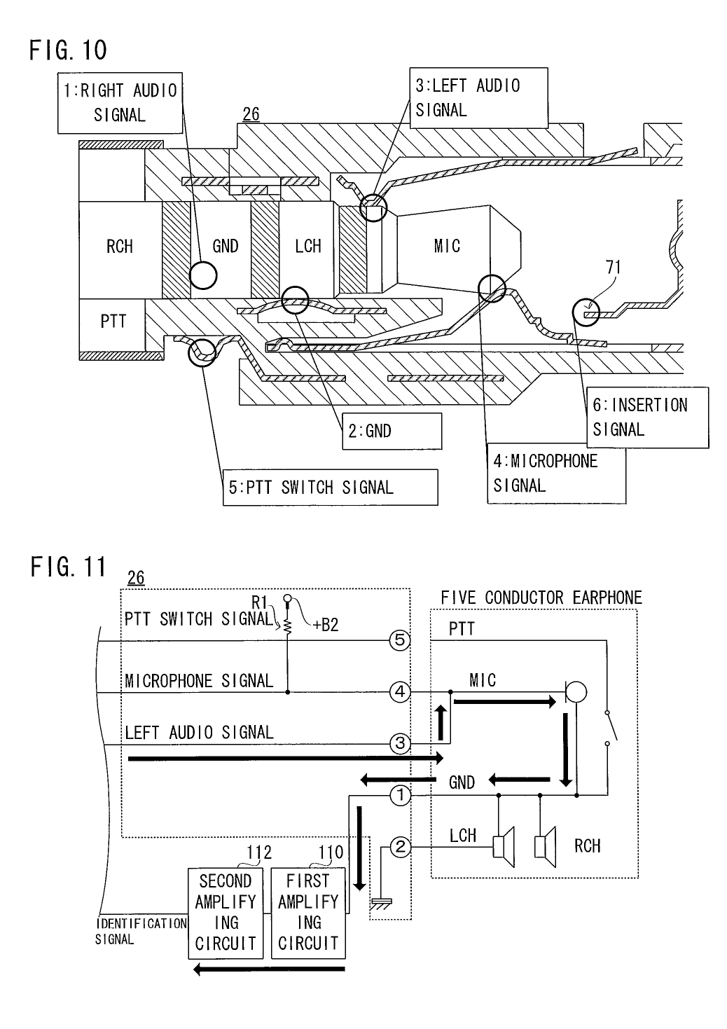

On the other hand, FIG. 9 is an illustrative view showing an electrical connection with the five conductor earphone plug inserted into the earphone jack 26. Here, similar to FIG. 7, unnecessary circuit components are also omitted in FIG. 9. With reference to FIG. 9, a tone signal is input from the third jack terminal to the left earpiece (Lch). At this time, the GND terminal 54a of the five conductor earphone plug is connected to the grounded second jack terminal, so that a leakage signal does not flow into the first jack terminal. That is, the controlling circuit 70 identifies the insertion of the five conductor earphone plug in a case that a loop of the tone signal is not detected in the first jack terminal during outputting the tone signal.

Next, the four conductor earphone mode to be set when insertion of the four conductor earphone plug is identified is described. In a case that the four conductor earphone mode is set, the setting of the output audio signal, the setting of the echo canceler 76, and the setting of the sound gain are changed.

When the four conductor earphone mode is set to change the setting of the output audio signal, the output of the left audio signal is kept, but an amplification factor of the second analog amplifier 84 is decreases, so that the output of the right audio signal is suspended. In this case, as understood from FIG. 7, the right and left earpieces are arranged in series with respect to the GND, so that sounds equal in volume are output from the right and left earpieces. Furthermore, in a case that stereo sound is output, the controlling circuit 70 synthesizes the right and left signals by the selector 81 to output a synthesized sound from the third jack terminal. That is, in a case that the four conductor earphone plug is inserted as well, it is possible to output sounds from the right and left earpieces. It should be noted that with the four conductor earphone mode, the volume is set to be higher than when the five conductor earphone plug is inserted.

Additionally, when the controlling circuit 70 changes the setting of the echo canceler 76, the parameter of the echo detecting sensitivity becomes high. When the parameter goes high, the echo detecting level of the echo canceler 76 goes low, and thus, even with little echo, sound on the side of the sending speech is muted. Accordingly, in a case that the four conductor earphone is used, the double talk performance slightly degrades due to the echo canceler 76, but predetermined speech quality can be ensured.

On the other hand, in a case that insertion of the five conductor earphone is detected, the jack terminals of the earphone jack 26 and the terminals of the five conductor earphone plug are connected in one-to-one correspondence, so that it is possible to normally output the sound. Furthermore, the parameter of the echo canceler 76 is not set to be high, and thus, the frequency of sound on the side of the sending speech being muted or attenuated is low, and thus, high speech quality can be ensured.

In this embodiment, the difference of the internal circuit between the four conductor and five conductor earphones is thus utilized to thereby identify the insertion of these earphone plugs, and therefore, it becomes possible to suitably use the earphones each having different number of terminals. Also, the number of terminals of the earphone jack 26 required for identification is decreased to thereby downsize the earphone jack 26.

Additionally, in a case that four conductor earphones for mobile phone apparatus that are available more on the market are used, by setting the four conductor earphone mode, it is possible to implement less volume difference between the right and left earpieces, and less degradation of the speech quality due to the echo.

Next, incorrect identification between the four conductor earphone plug and the five conductor earphone plug occurring when the earphone plug is inserted is described. For example, when the five conductor earphone plug is slowly inserted into the earphone jack 26, the inside of the earphone jack 26 is as shown in FIG. 10.

With reference to FIG. 10, in a cross-sectional view of the earphone jack 26 in a state that the five conductor earphone plug is inserted, the first jack terminal is in contact with the GND terminal 54a, the second jack terminal is in contact with the left audio terminal 52a, and the third jack terminal and the fourth jack terminal are in contact with the microphone terminal 50a. That is, the third jack terminal and the fourth jack terminal short out by the microphone terminal 50a. Also, in this state, the fifth jack terminal is not in contact with the switch terminal 58a, but the sixth jack terminal is spaced from the contact 71 of the fourth jack terminal, so that the detection signal goes “L (insertion)”, resulting in an input of the tone signal to the third jack terminal.

That is, in the state shown in FIG. 10, while the third jack terminal and the fourth jack terminal short out, the tone signal is input to the third jack terminal. The circuit diagram in this state is shown in FIG. 11.

With reference to FIG. 11, in a case that a measure described later is not taken, the tone signal output from the third jack terminal flows into the first jack terminal through the earphone microphone as a leakage signal. That is, irrespective of insertion of the five conductor earphone plug, the identification signal is input to the controlling circuit 70 to thereby incorrectly identify the insertion of the four conductor earphone plug which should not be identified.

Hereupon, in this embodiment, after a lapse of a predetermined time (500 ms, for example) from the detection of the insertion of the earphone plug, the tone signal is output. Furthermore, during outputting the tone signal, the voltage bias (microphone bias) applied to the fourth jack terminal from the +B2 port is turned off to make the earphone microphone inactive. As a result, the impedance of the earphone microphone becomes high, and the leakage signal unintentionally flowing through the earphone microphone is reduced. Accordingly, even if the earphone plug is slowly inserted into the earphone jack 26, incorrect identification never occurs.

Also, in a case that the earphone plug is slowly inserted, incorrect identification may occur due to chatter, and therefore, in this embodiment, by taking the hysteresis using the above-described changes in the pulse signal, it is possible to prevent incorrect identification when the earphone plug is slowly inserted from occurring.

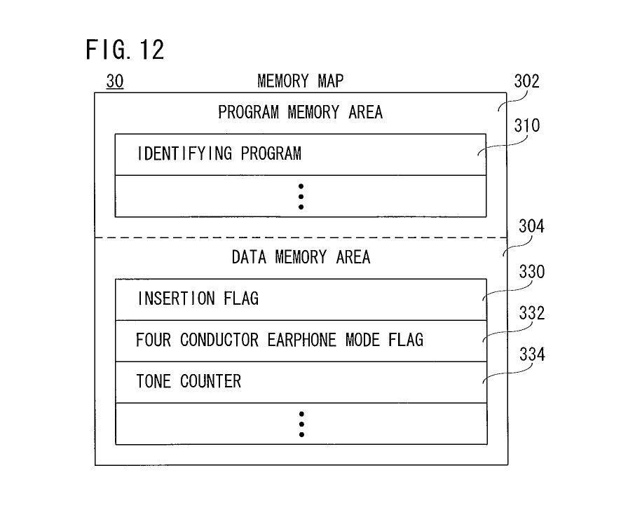

FIG. 12 is an illustrative view showing a memory map of the RAM 30. In the memory map of the RAM 30, a program memory area 302 and a data memory area 304 are included. A part of programs and data are read entirely at a time, or partially and sequentially as necessary from the flash memory 28, stored in the RAM 30, and then executed by processor 18 (or the controlling circuit 70).

In the program memory area 302, a program for operating the mobile phone apparatus 10 is stored. For example, the program for operating the mobile phone apparatus 10 includes an identifying program 310, etc. The identifying program 310 is a program for identifying whether the earphone plug inserted into the earphone jack 26 is the five conductor earphone plug or the four conductor earphone plug.

Although illustration is omitted, the program for operating the mobile phone apparatus 10 includes a program of notifying a sound incoming condition, and a program of executing a PTT function, etc.

Succeedingly, in the data memory area 304, an insertion flag 330, a four conductor earphone mode flag 332, a tone counter 334, etc. are provided. The insertion flag 330 is a flag for determining whether or not the earphone plug is inserted, and switched between ON and OFF based on the insertion signal. For example, the insertion flag 330 is made up of a one-bit register. When the insertion flag 330 is turned on (established), a data value “1” is set to the register. On the other hand, when the insertion flag 330 is turned off (not established), a data value “0” is set to the register.

The four conductor earphone mode flag 332 is a flag for indicating whether or not the four conductor earphone mode is set. Also, the four conductor earphone mode flag 332 has a configuration the same as that of the insertion flag 330, and thus, the detailed description is omitted.

The tone counter 334 is a counter for measuring a predetermined time (100 ms, for example), and starts counting (measuring) when being reset (initialized).

Although illustration is omitted, in the data memory area 304, address data including phone numbers and mail addresses of other mobile phone apparatuses, and a decoding result of the received audio signal are stored, and counters and flags necessary for operating the mobile phone apparatus 10 are also provided.

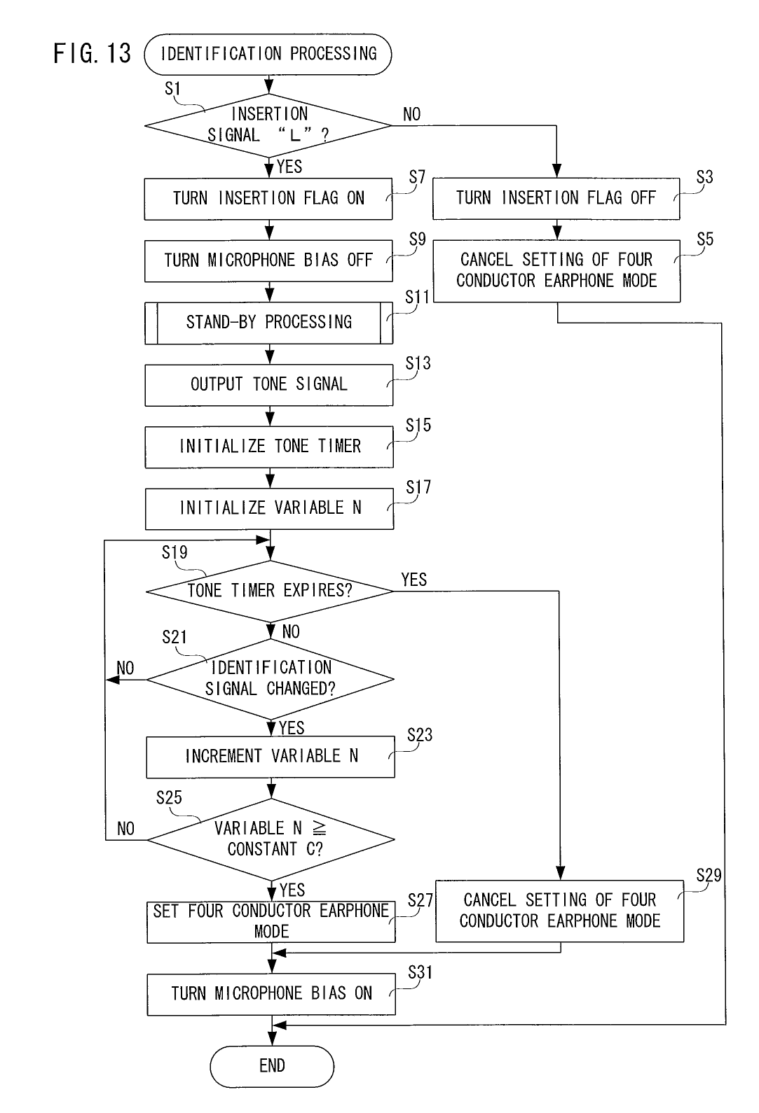

The processor 18 performs a plurality of tasks including the identification processing, etc. shown in FIG. 13 in parallel under the control of Linux (registered trademark)-based OSes such as Android (registered trademark), REX, etc. and other OSes.

FIG. 13 is a flowchart showing identification processing. For example, when the state of the insertion signal changes, the controlling circuit 70 (processor 18) determines whether or not the insertion signal is “L” in a step S1. That is, whether or not the earphone plug is inserted into the earphone jack 26 is determined. If “NO” in the step S1, that is, if the earphone plug is withdrawn, and the insertion signal is “H”, for example, the insertion flag 330 is turned off in a step S3. Succeedingly, in a step S5, setting of the four conductor earphone mode is cancelled. That is, the four conductor earphone mode flag 332 is turned off. Then, when the four conductor earphone mode flag 332 is turned off, the left audio signal is set to be output from the third jack terminal, and the right audio signal is set to be output from the first jack terminal. Also, the setting of the parameter of the echo canceler 76 and the setting of the sound gain are changed to be used for the five conductor earphone. Then, after completion of the processing in the step S5, the identification processing is ended.

On the other hand, if “YES” is determined in the step S1, that is, if the earphone plug is inserted into the earphone jack 26, the insertion flag 330 is turned on in a step S7. Succeedingly, in a step S9, the microphone bias is turned off. That is, the voltage bias (microphone bias) applied from the +B2 port to the fourth jack terminal is turned off. Then, in a step S11, stand-by processing is executed. That is, for preventing the earphone plug from being incorrectly identified, the stand-by processing is executed. Also, when the stand-by processing is executed, a stand-by timer for a predetermined time (500 ms) is reset. The processing in the step S11 is continuously executed until the stand-by timer expires. Here, the controlling circuit 70 (processor 18) executing the processing in the step S11 functions as an executing unit.

Succeedingly, in a step S13, a tone signal is output. For example, an instruction of outputting the tone signal of 400 Hz/90 mVp-p is issued to the DTMF generator 96. Then, in a step S15, the tone timer is initialized. That is, the tone counter 334 is initialized for measuring the time during which the tone signal continues to be output. Succeedingly, in a step S17, a variable N is initialized. That is, since the variable N is used for counting the changes of the identification signal being a pulse signal, the initialization in the step S17 is made.

Succeedingly, in a step S19, it is determined whether or not the tone timer expires. That is, it is determined whether or not a predetermined time has elapsed from the output of the tone signal. If “NO” in the step S19, that is, if the tone timer does not expire, it is determined whether or not the identification signal is changed in a step S21. That is, it is determined whether or not the change of the pulse signal is input to the controlling circuit 70. If “NO” in the step S21, that is, if the identification signal does not change, the process returns to the step S19. On the other hand, if “YES” is determined in the step S21, that is, if the identification signal changes, the variable N is incremented in a step S23. For example, if the variable N is incremented from “0”, the variable N becomes “1”. Succeedingly, in a step S25, it is determined whether or not the variable N is equal to or more than a constant C (3, for example). That is, it is determined whether or not the change of the identification signal is equal to or more than the predetermined number of times. If “YES” is determined in the step S25, that is, if the change of the identification signal is detected three times, the four conductor earphone mode is set in in a step S27. That is, the four conductor earphone mode flag 332 is turned on. Then, when the four conductor earphone mode flag is turned on, setting is made such that the right and left audios are synthesized, and the synthesized sound is output from the third jack terminal. In addition, the setting of the parameter of the echo canceler 76 and the setting of the sound gain are changed to be used for four conductor earphone. Then, after completion of the processing in the step S27, an instruction of suspending the output of the tone signal is issued to the DTMF generator 96. Here, the controlling circuit 70 executing the processing in the steps S19-S25 functions as an identifying unit. Also, the controlling circuit 70 executing the processing in the step S27 functions as a setting unit.

Alternatively, if “NO” in the step S25, for example, if the variable N is “2”, that is, it is less than the constant C, the process returns to the step S19. Furthermore, if “YES” is determined in the step S19, that is, if the tone timer expires before the identification signal changes predetermined number of times, the setting of the four conductor earphone mode is cancelled similar to the step S5 in a step S29. In addition, after completion of the processing in the step S29, an instruction of suspending the output of the tone signal is issued to the DTMF generator 96.

Then, after completion of the processing in the step S27 or the step S29, the microphone bias is turned on in a step S31. That is, the voltage bias applied to the fourth jack terminal from the +B2 port is turned on. Furthermore, after completion of the processing in the step S31, the identification processing is ended.

Here, in the first embodiment, the leakage signal is amplified by the class B amplifier circuits 110, 112 in the two stages, but in another embodiment, other amplifier circuits may be used. Additionally, the number of amplifier circuits need not be restricted to two, and may be one or three or more. Also, the two amplifier circuits may be connected to the fourth jack terminal which receives an input of a microphone signal.

In another embodiment, the tone signal may be output to the first jack terminal. In this case, the two amplifier circuits may be provided to the third jack terminal or the fourth jack terminal.

### Second Embodiment

In the second embodiment, when the inserted earphone is identified, the jack terminal which receives an input of a right audio is input and the grounded jack terminal are switched on the basis of the result of the identification. Thus, irrespective of the kind of the used earphone, the stereo sound is output from the earphone.

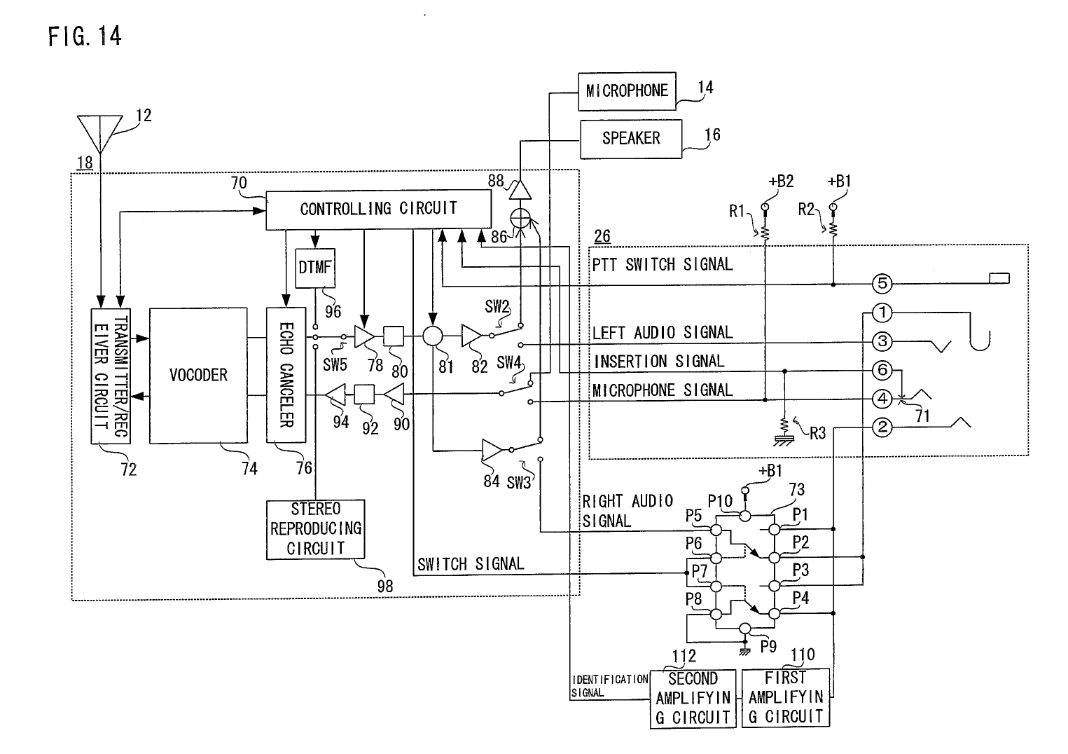

FIG. 14 is an illustrative view showing an electric configuration around the processor 18 and the earphone jack 26 of the second embodiment. Here, the processor 18 and the earphone jack 26 of the second embodiment are approximately the same as those of the first embodiment, and therefore, the description is made only on the different point from the first embodiment.

The processor 18 further includes a stereo sound reproducing circuit 98, and is provided with a switch SW5 in place of the switch SW1. Furthermore, the controlling circuit 70 outputs a switching signal for simultaneously switching a plurality of SPDT switches to an analog switch 73.

First, the stereo sound reproducing circuit 98 is a circuit for generating right and left audio signals (stereo sound signals) from music data, etc. For example, in a case that a music player function is executed, the processor 18 reads music data from the flash memory 28. The processor 18 inputs the read music data to the stereo sound reproducing circuit 98 to generate a stereo sound signal.

The switch SW5 is connected with the echo canceler 76, the DTMF generator 96 and the stereo sound reproducing circuit 98. Furthermore, the state of the switch SW5 is switched depending on the state of the mobile phone apparatus 10. Then, when the switch SW5 is switched, the output of any one of the echo canceler 76, the DTMF generator 96 and the stereo sound reproducing circuit 98 is input to the first digital gain 78.

For example, in a case that the processor 18 executes the speech communication processing, the controlling circuit 70 controls the switch SW5 to input the output from the echo canceler 76 (receiver sound) to the first digital gain 78. At this time, if the communication partner is during the speech communication, etc., the controlling circuit 70 controls the switch SW5 to input the output (tone signal) from the DTMF generator 96 to the first digital gain 78. Or, in a case that the processor 18 executes the music player function, the controlling circuit 70 controls the switch SW5 to input the output from the stereo sound reproducing circuit 98 (stereo sound signal) to the first digital gain 78.

Also, in a case that the processor 18 executes the music player function, the controlling circuit 70 controls the selector 81 to input the right and left audio signals to the respective paths. That is, in the selector 81, the left audio is input to the left audio path, that is, to the first analog amplifier 82, and the right audio is input to the right audio path, that is, to the second analog amplifier 84. At this time, if no earphone is inserted, the right and left audio signals are synthesized by the adder 86, and the synthesized audio signal is further amplified by the third analog amplifier 88, and is then given to the speaker 16. On the other hand, if the earphone is inserted, the left audio and right audio are output from the right and left earpieces.

Here, in a case that a radio function, TV function (one-segment function), a video replay function, etc. are executed by the processor 18 as well, the stereo sound reproducing circuit 98 may produce stereo sound.

Next, the earphone jack 26 is connected to the aforementioned analog switch 73. The first jack terminal of the second embodiment is connected to a port P2 and a port P3 of the analog switch 73 functioning as a switching unit. Depending on the switching state of the analog switch 73, the first jack terminal receives an input of the right audio signal, or is connected to the GND.

The second jack terminal is connected to a port P1 and a port P4 of the analog switch 73. Then, depending on the switching state of the analog switch 73, the second jack terminal is connected to the GND, or receives an input of the right audio signal.

The above-described analog switch 73 includes two SPDT (Single Pole Double Throw) switches. Furthermore, the analog switch 73 has the aforementioned ports P1-P4 to which the first jack terminal or the second jack terminal is connected. A port P5 is connected to the switch SW3, and receives an input of a right audio signal with the earphone inserted. Ports P6, P7 are connected to the processor 18, and receive an input of a switching signal from the processor 18. Ports P8, P9 are connected to the GND. A Port P10 is connected to the +B1 port of the power supply circuit 32.

Furthermore, the one SPDT switch consists of the ports P1, P2, P5, and another SPDT switch consists of ports P3, P4, P8. By the switching signal to be input to the aforementioned ports P6, P7, the two SPDT switches are simultaneously switched.

For example, when the right audio signal is input to the port P5, it is output from the port P1 or the port P2 depending on the switching state of the SPDT switch. Furthermore, the port P3 or the port P4 is connected to the grounded port P8 depending on the switching state of the SPDT switch.

As shown in FIG. 14, in an initial state, the analog switch 73 is switched so as to correspond to the arrangement of the terminals of the five conductor earphone plug. Thus, with respect to the SPDT switch which receives an input of the right audio signal, the port P2 (first jack terminal) to be connected to the right audio terminal of the five conductor earphone plug is connected to the port P5. Furthermore, with respect to the SPDT switch connected to the GND, the port P4 (second jack terminal) to be connected to the GND terminal of the five conductor earphone plug is connected to the port P8. In this case, the ports P3 and P1 are not in contact with the other terminals. Furthermore, the switching signal in the initial state is set to the “L” status.

Here, if the inserted earphone plug is identified as a four conductor earphone plug, the controlling circuit 70 sets the switching signal to the “H” status to simultaneously switch the two SPDT switches included in the analog switch 73. That is, with respect to the SPDT switch which receives an input of the right audio signal, the port P1 (second jack terminal) to be connected with the right audio terminal of the four conductor earphone plug is connected to the port P5. Also, with respect to the SPDT switch connected to the GND, the port P3 (first jack terminal) to be connected with the GND terminal of the four conductor earphone plug is connected to the port P8.

Therefore, in a case that insertion of the four conductor earphone plug is judged, the analog switch 73 is switched such that the first jack terminal is grounded, and the right audio signal is output to the second jack terminal.

In the second embodiment, the terminal to which the right audio is to be output is selected on the basis of the identification result. Thus, even if the four conductor earphone plug is inserted, stereo sound can be output from the earphone.

Additionally, in the second embodiment, the four conductor earphone mode is not required to be set. Specifically, unlike the first embodiment, the parameter of the echo detecting sensitivity of the echo canceler 76 need not be made high, and thus, even if the four conductor earphone is used, it is possible to retain speech quality as in the use of the five conductor earphone.

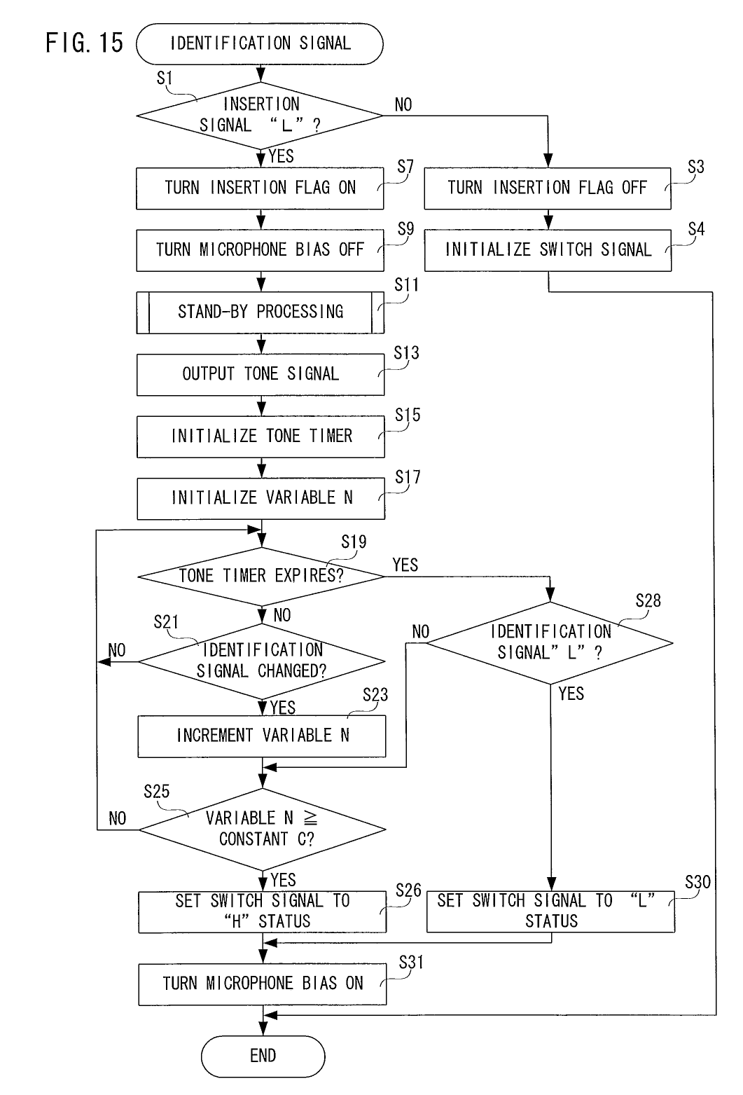

FIG. 15 is a flowchart showing the identification processing of the second embodiment. Here, as to the processing the same as the identification processing of the first embodiment, the same reference numerals are applied. For example, when the status of the insertion signal changes, the controlling circuit 70 (processor 18) determines whether or not the insertion signal goes “L” in a step S1. If “NO” in the step S1, that is, if the earphone plug is withdrawn, and the insertion signal goes “H”, the processor 18 turns the insertion flag 330 off in a step S3.

Succeedingly, the processor 18 initializes the switching signal in a step S4, and ends the identification processing. That is, the switching signal input to the analog switch 73 changes “L”.

On the other hand, if “YES” is determined in the step S1, that is, if the earphone plug is inserted, and the insertion signal changes “L”, the processor 18 turns the insertion flag 330 on in a step S7 and turns the microphone bias off in a step S9. Succeedingly, the processor 18 executes stand-by processing in a step S11, outputs a tone signal in a step S13, initializes the tone timer in a step S15, and initializes the variable N in a step S17.

Then, in a step S19, it is determined whether or not the tone timer expires. If “NO” in the step S19, that is, if a predetermined time has not elapsed from the output of the tone signal, the processor 18 determines whether or not the identification signal changes in a step S21. If “NO” in the step S21, that is, if the identification signal does not change, the process returns to the step S19. On the other hand, if “YES” is determined in the step S21, that is, if the identification signal changes, the processor 18 increments the variable N for counting the number of changes of the identification signal in a step S23. Succeedingly, in a step S25, the processor 18 determines whether or not the variable N is equal to or more than the constant C. That is, it is determined whether or not the number of changes of the identification signal is equal to or more than the predetermined number of times.

If “YES” is determined in the step S25, that is, if the number of changes of the identification signal is equal to or more than the predetermined number of times, the processor 18 sets the switching signal to the “H” status in a step S26. That is, since the earphone plug of the four conductor earphone is inserted, the two SPDT switches included in the analog switch 73 are simultaneously switched. Thus, the port P1 to be connected with the right audio terminal of the four conductor earphone plug is connected to the port P5, and the port P3 to be connected with the GND terminal of the four conductor earphone plug is connected to the port P8. As a result, a right audio signal is input to the right audio terminal 56b of the four conductor earphone plug, and GND terminal 54b is grounded.

On the other hand, if “NO” in the step S25, that is, if the variable N is less than the constant C, the processor 18 returns to the processing in the step S19. If “YES” is determined in the step S19, that is, if the predetermined time has elapsed from the output of the tone signal, the processor 18 determines whether or not the identification signal is “L” in a step S28. That is, after the lapse of the predetermined time from the output of the tone signal as well, it is determined whether or not the identification signal does not change. If “NO” in the step S28, that is, if the identification signal changes “H”, the processor 18 returns to the step S25.

Alternatively, if “YES” is determined in the step S28, that is, if the identification signal remains “L”, the processor 18 sets the switching signal to the “L” status in a step S30. That is, since the earphone plug of the five conductor earphone is inserted, the two SPDT switches included in the analog switch 73 are set to the initial state. Thus, as a result, the right audio signal is input to the right audio terminal 56a of the five conductor earphone plug, and the GND terminal 54a is grounded.

Then, after completion of the processing in the step S26 or the step S30, the processor 18 turns the microphone bias on to end the identification processing in a step S31.

### Third Embodiment

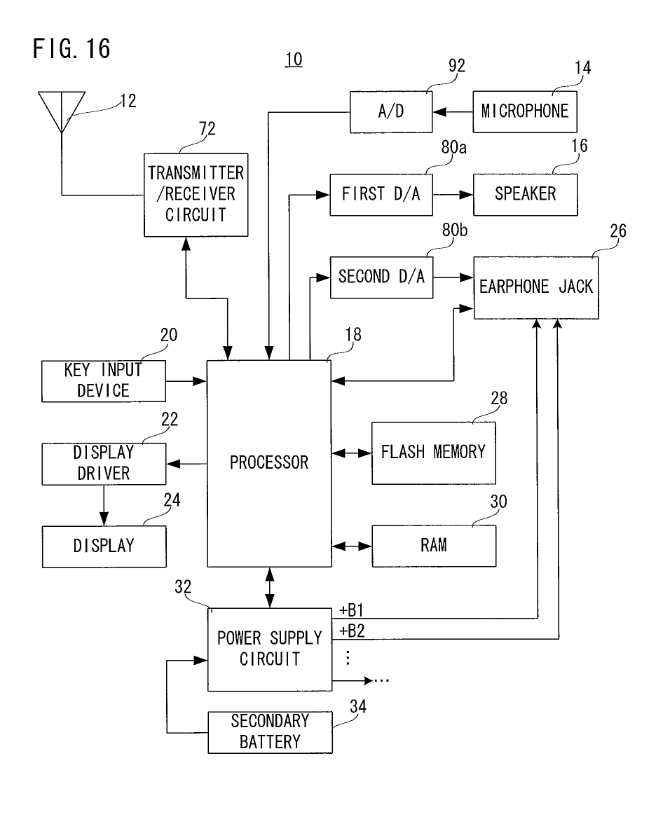

With reference to FIG. 16, the mobile phone apparatus 10 of the third embodiment includes the processor 18 called a computer or a CPU. Furthermore, the processor 18 is connected with the transmitter/receiver circuit 72, the A/D converter 92, a first D/A converter 80a, the key input device 20, the display driver 22, the flash memory 28, the RAM 30 and the power supply circuit 32, etc.

The transmitter/receiver circuit 72 is connected with the antenna 12. The A/D converter 92 is connected to the microphone 14, the first D/A converter 80a is connected to the speaker 16, and a second D/A converter 80b is connected to the earphone jack 26. The display driver 22 is connected to the display 24. The power supply circuit 32 is connected to the secondary battery 34, etc. Here, the earphone jack 26 is also connected to the processor 18 and the power supply circuit 32.

Here, the electric configuration of the mobile phone apparatus 10 of the third embodiment is different from those of the first embodiment and the second embodiment, but like parts are identified by the same reference numeral as in the first embodiment and the second embodiment.

The processor 18 totally controls the mobile phone apparatus 10. The A/D converter 92 converts an analog audio signal as to a sound or tone input trough the microphone 14 into a digital audio signal. The first D/A converter 80a converts (decodes) a digital audio signal into an analog audio signal, and applies the analog audio signal to the speaker 16 through an amplifier not shown. Accordingly, sound or tone corresponding to the analog audio signal is output from the speaker 16. Here, the processor 18 can adjust the volume of the sound output from the speaker 16 by controlling an amplification factor of the amplifier.

Similarly, the second D/A converter 80b also converts (decodes) a digital audio signal into an analog audio signal and applies the analog audio signal to the earphone jack 26 through an amplifier not shown. Here, the processor 18 can adjust the volume of the sound output from the earphone by controlling an amplification factor of the amplifier connected to the second D/A converter 80b.

The transmitter/receiver circuit 72 is a circuit for making a wireless communication in a CDMA system. For example, when the user commands telephone transmission (outgoing call) by using the key input device 20, the transmitter/receiver circuit 72 executes telephone transmission processing under the control of the controlling circuit 70, and outputs a phone transmission signal via the antenna 12. The phone transmission signal is transmitted to the telephone of the communication partner through the base stations and a communication network (not illustrated). Then, when incoming call processing is performed in the telephone of the communication partner, a communication capable state is established, and the processor 18 executes speech communication processing.

Describing a normal speech communication processing in detail, a modulated audio signal transmitted from the telephone of the communication partner is received by the antenna 12. The received modulated audio signal undergoes demodulation processing and decoding processing by the transmitter/receiver circuit 72. Then, the received voice signal acquired by such processing is converted into an analog audio signal by the first D/A converter 80a, and the analog audio signal is output from the speaker 16. On the other hand, a voice signal to be transmitted taken through the microphone 14 is converted into a digital audio signal by the A/D converter 92, and the digital audio signal is applied to the processor 18. The voice signal to be transmitted which has been converted into the digital audio signal undergoes encoding processing and modulation processing by the transmitter/receiver circuit 72 under the control of the processor 18, and the modulated audio signal is output via the antenna 12. Accordingly, the modulated audio signal is transmitted to the telephone of the communication partner via the base stations and communication networks.

In addition, when a phone transmission signal from the telephone of the communication partner is received by the antenna 12, the transmitter/receiver circuit 72 notifies the processor 18 of telephone reception (incoming call). In response thereto, the processor 18 controls the display driver 22 to display calling source information (phone number, etc.) described in the incoming call notification on the display 24. Approximately the same time, the processor 18 also outputs an incoming call tone (sometimes referred to be incoming call melody, ring tone.) from the speaker not shown.

Then, when the user performs an answer operation by using the off-hook key, the transmitter/receiver circuit 72 executes phone reception processing under the control of the processor 18. In addition, when a communication capable state is established, the processor 18 executes the above-described normal speech communication processing.

Furthermore, after a transition to the speech communication allowable state, when a speech communication end operation is performed by the on-hook key, the processor 18 controls the transmitter/receiver circuit 72 to transmit a speech communication end signal to the communication partner. Then, after transmission of the speech communication end signal, the processor 18 ends the speech communication processing. Or, when a speech communication end signal is received from the communication partner as well, the processor 18 ends the speech communication processing. In addition, if a speech communication end signal is received from the mobile communication network irrespective of the communication partner, the processor 18 ends the speech communication processing.

In the third embodiment here, the kind of the earphone plug inserted into the earphone jack 26 is identified, whereby the jack terminal of the earphone jack 26 to output the right audio signal and the jack terminal connected to the GND are suitably selected.

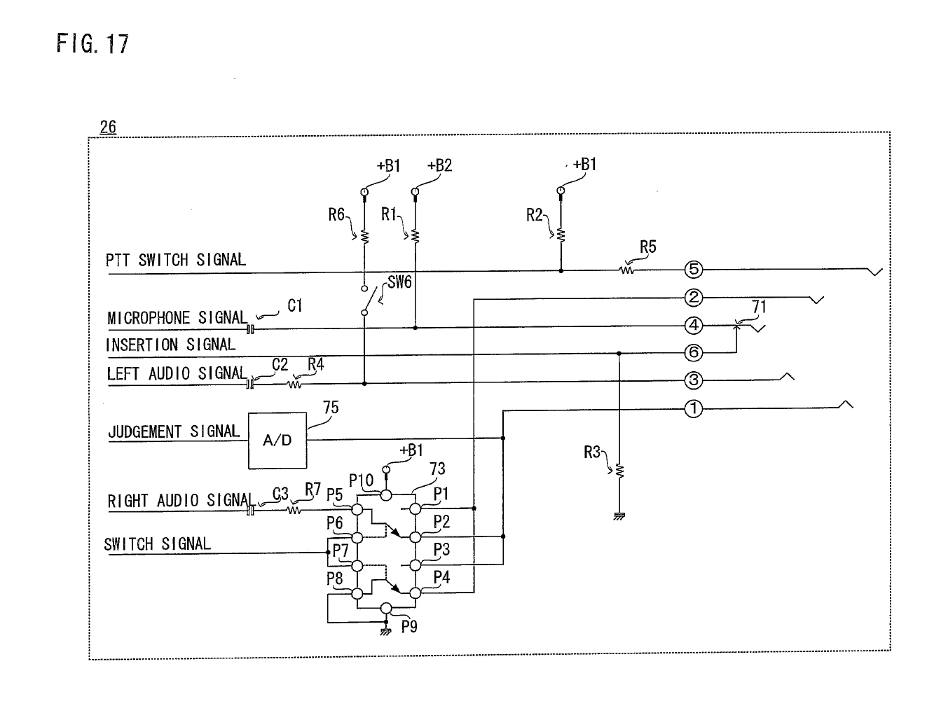

FIG. 17 is an illustrative view showing another example of an electric configuration of the earphone jack 26. With reference to FIG. 17, the earphone jack 26 includes the first jack terminal (first terminal, third terminal) to be in contact with the right audio terminal 56a of the five conductor earphone plug or the GND terminal 54b of the four conductor earphone plug, the fourth jack terminal to be in contact with the microphone terminal 50, the third jack terminal (second terminal, first terminal) to be in contact with the left audio terminal 52, the second jack terminal (third terminal, second terminal) to be in contact with the GND terminal 54a of the five conductor earphone plug or the right audio terminal 56b of the four conductor earphone plug, the sixth jack terminal to be in contact with the fourth jack terminal by a contact 71 and the fifth jack terminal to be in contact with with the switch terminal 58a of the five conductor earphone plug.

The first jack terminal is connected to the port P2 and the port P3 of the analog switch 73 functioning as a switching unit. Furthermore, between the contact of the first jack terminal and the analog switch 73, the A/D converter 75 for outputting a judgment signal to the processor 18 is connected. Although the detail is described later, by utilizing as a judgment signal the output from the A/D converter 75 functioning as a detecting unit, the processor 18 judges whether the four conductor earphone plug or five conductor earphone plug is inserted. Then, the first jack terminal receives an input of the right audio signal or is connected to the GND in accordance with the switching state of the analog switch 73.

The fourth jack terminal is connected to the processor 18 through a capacitor C1 with a value of 0.1 μF and an A/D converter not shown. Also, between the contact 71 of the fourth jack terminal and the capacitor C1, the +B2 port of the power supply circuit 32 is connected through a resistor R1 with a value of 2 kΩ. Moreover, the fourth jack terminal receives an analog audio signal relative to a sound or tone input through the PTT earphone or the microphone of the handsfree earphone. Thus, the input analog audio signal is converted into a digital audio signal by the aforementioned A/D converter, and is then output to the processor 18 as a microphone signal. Here, the processor 18 can detect a voltage value of the microphone signal, and stores the detected voltage value in an earphone switch buffer 338 of the RAM 30.

The third jack terminal is connected to the processor 18 through a resistor R4 with a value of 33Ω and a capacitor C2 with a value of 22 μF. Furthermore, between the contact of the third jack terminal and the resistor R4, the +B1 port of the power supply circuit 32 is connected through a judgment switch SW6 and a resistor R6 with a value of 100Ω. Here, digital audio of the left channel output by the processor 18 is converted into an analog audio signal by the second D/A converter 80b and input to the third jack terminal.

The second jack terminal is connected to the port P1 and the port P4 of the analog switch 73. Then, the second jack terminal is connected to the GND or receives an input of a right audio signal depending on the switching state of the analog switch 73.

The sixth jack terminal is connected to the processor 18. Also, between the contact 71 and the processor 18, it is connected to the GND through a resistor R3 with a value of 33 kΩ. In addition, with the earphone plug not inserted, the contact 71 of the sixth jack terminal is in contact with the fourth jack terminal as described above, and with the earphone plug inserted, the contact 71 is separated from the fourth jack terminal. Then, since the fourth jack terminal is connected to the +B2 port, if the contact 71 is in contact with the fourth jack terminal, a voltage is applied to the sixth jack terminal. On the other hand, if the contact 71 is not in contact with the fourth jack terminal, no voltage is applied to the sixth jack terminal. Thus, the voltage value of the sixth jack terminal is utilized as an insertion signal of the earphone plug.

For example, if the earphone plug is not inserted, a voltage is applied to the sixth jack terminal to make the insertion signal “H”, and thus, the processor 18 determines that the earphone plug is not inserted. On the other hand, if the earphone plug is inserted, no voltage is applied to the sixth jack terminal to make the insertion signal “L”, and thus, the processor 18 determines that the earphone plug is inserted.

The fifth jack terminal is connected to the processor 18 through a resistor R5 with a value of 1 kΩ. Furthermore, between the resistor R5 and the processor 18, the +B1 port of the power supply circuit 32 is connected through a resistor R2 with a value of 10 kΩ. Then, the voltage value applied to the fifth jack terminal changes depending on the ON/Off states of the PTT switch, and thus, the voltage value is utilized as PTT switch signal.

The above-described analog switch 73 includes two SPDT (Single Pole Double Throw) switches. Also, the analog switch 73 has the ports P1-P4 to which the first jack terminal or the second jack terminal is connected as described above. The port P5 is connected to the processor 18 through a resistor R7 with a value of 33Ω and a capacitor C3 with a value of 22 μF, and receives an input of the right audio signal. The ports P6, P7 are connected to the processor 18, and both receive an input of the switching signal from the processor 18. The ports P8, P9 are connected to the GND. Then, the port P10 is connected to the +B1 port of the power supply circuit 32.

Additionally, the one SPDT switch consists of the ports P1, P2, P5, and the other SPDT switch consists of the ports P3, P4, P8. Then, by the switching signal input to the aforementioned ports P6, P7, the two SPDT switches are simultaneously switched.

For example, when the right audio signal is input to the port P5, it is output from the port P1 or the port P2 depending on the switching state of the SPDT switch. Furthermore, the port P3 or the port P4 is connected to the grounded port P8 depending on the switching state of the SPDT switch.

In addition, as shown in FIG. 17, in an initial state, the analog switch 73 is switched so as to correspond to the arrangement of the terminals of the five conductor earphone plug, and thus, with respect to the SPDT switch which receives an input of the right audio signal, the port P2 (first jack terminal) to be connected with the right audio terminal of the five conductor earphone plug is connected to the port P5. Also, with respect to the SPDT switch connected to the GND, the port P4 (second jack terminal) to be connected with the GND terminal of the five conductor earphone plug is connected to the port P8.

In this case, the port P3 and the P1 are not in contact with the other terminals. Furthermore, the switching signal in the initial state is set to the “L” status.

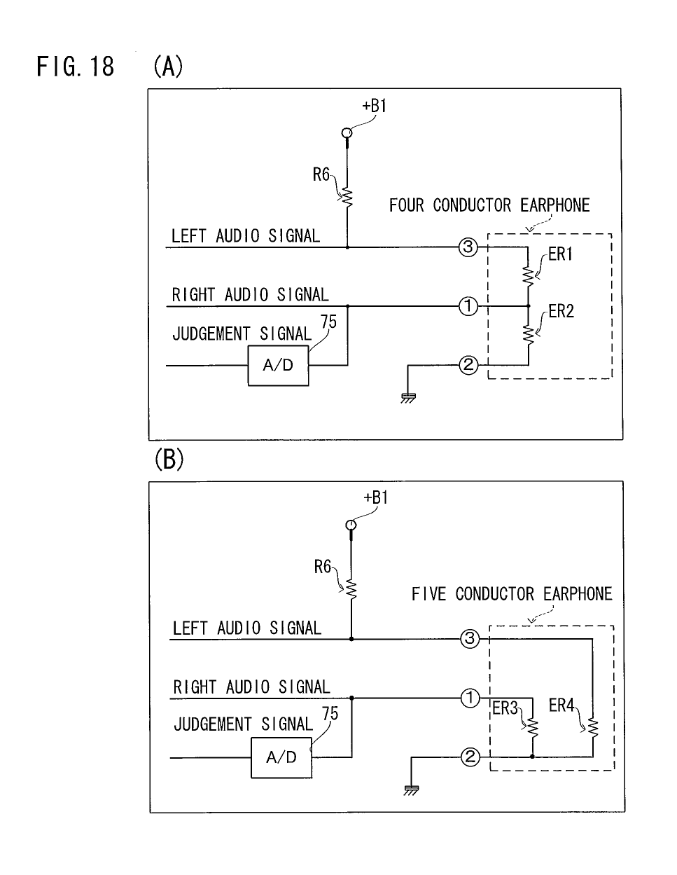

Here, when the four conductor earphone plug is inserted into the earphone jack 26, the insertion signal goes “H” to turn the judgment switch SW6 on. At this time, an equivalent circuit representing the periphery of the first jack terminal, the third jack terminal, the second jack terminal and the four conductor earphone are as shown in FIG. 18(A). With reference to FIG. 18(A), the four conductor earphone includes a resistor ER1 and a resistor ER2 each having a value of 32Ω connected in series. Furthermore, one end of the resistor ER1 is connected to the third jack terminal, the other end of the resistor ER2 is connected to the second jack terminal, and the first jack terminal is connected between the resistor ER1 and the resistor ER2. In this state, the voltage from the +B1 port of the power supply circuit 32 is applied to the four conductor earphone via the resistor R6 and the third jack terminal, and by the voltage division utilizing the resistor ER1 and the resistor ER2, a voltage (0.507 V, for example) is applied to the first jack terminal. Therefore, the detection signal output from the A/D converter 75 goes “H”.

Then, if the detection signal goes “H”, the processor 18 sets the switching signal to the “H” status to simultaneously select the two SPDT switches included in the analog switch 73. That is, with respect to the SPDT switch which receives an input of the right audio signal, the port P1 (second jack terminal) to be connected with the right audio terminal of the four conductor earphone plug is connected to the port P5. Furthermore, with respect to the SPDT switch connected to the GND, the port P3 (first jack terminal) to be connected with the GND terminal of the four conductor earphone plug is connected to the port P8.

Therefore, in a case that insertion of the four conductor earphone plug is judged, the analog switch 73 is switched such that the first jack terminal is grounded, and the second jack terminal receives an input of the right audio signal.

Next, when the five conductor earphone plug is inserted into the earphone jack, an equivalent circuit representing the periphery of the first jack terminal, the third jack terminal, the second jack terminal and the five conductor earphone are as shown in FIG. 18(B). With reference to FIG. 18(B), the five conductor earphone includes a resistor ER3 and a resistor ER4 each having a value of 32Ω. One end of the resistor ER4 is connected to the third jack terminal, and the other is connected to the second jack terminal. Also, between the other end of the resistor ER4 and the second jack terminal, the first jack terminal is connected through the resistor ER3. In addition, in this state, the voltage from the +B1 port of the power supply circuit 32 is applied to the five conductor earphone through the resistor R6 and the third jack terminal. Then, the current produced by application of the voltage to the five conductor earphone flows down to the GND through the resistor ER4, but the presence of the resistor ER3 on the side of the first jack terminal prevents the voltage from being detected in the first jack terminal. That is, the detection signal output from the A/D converter 75 goes “L”.

Here, in this embodiment, even if the detection signal goes “L”, the initial state of the switching signal has been set to “L”, and thus, the analog switch 73 remains in the initial state as shown in FIG. 17.

Thus, in the initial state and in the state that it is judged that the five conductor earphone plug is inserted, the analog switch 73 is switched such that the first jack terminal receives an input of the right audio signal, and the second jack terminal is grounded.

As understood from the above description, by utilizing the difference in the internal circuit of the earphones, it is possible to judge whether the four conductor earphone plug or the five conductor earphone plug is inserted. Accordingly, the number of jack terminals required for judgment is reduced to downsize the earphone jack 26.

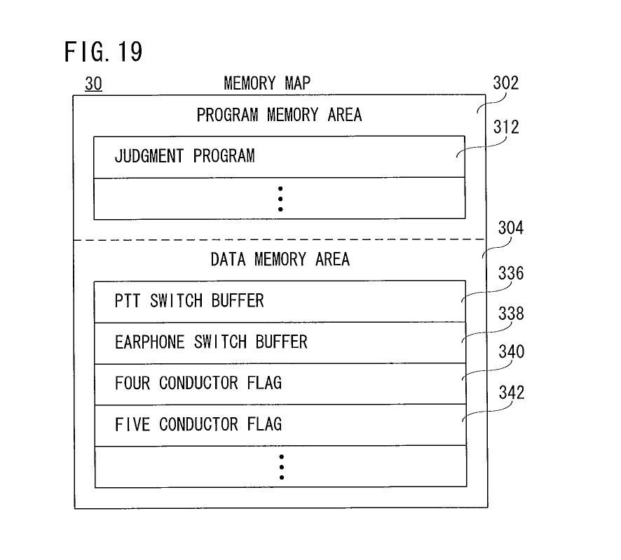

FIG. 19 is an illustrative view showing a memory map of the RAM 30. In the program memory area 302, a program for operating the mobile phone apparatus 10 is stored. For example, the program for operating the mobile phone apparatus 10 includes a judgment program 312, etc. The judgment program 312 is a program for judging whether the earphone plug inserted into the earphone jack 26 is the five conductor earphone plug or the four conductor earphone plug. Although illustration is omitted, the program for operating the mobile phone apparatus 10 includes a program of notifying a voice incoming condition, and a program of executing a PTT function, etc.

Then, the data memory area 304 is provided with a PTT switch buffer 336 and an earphone switch buffer 338, a four-conductor flag 340 and a five-conductor flag 342.

In the PTT switch buffer 336, a status of the PTT switch signal is temporarily stored. In the earphone switch buffer 338, the voltage value of the microphone signal representing the ON/OFF states of the earphone switch is temporarily stored.

The four-conductor flag 340 and the five-conductor flag 342 are flags for respectively determining whether the four conductor plug or the five conductor plug is inserted into the earphone jack 26. Then, both of the four-conductor flag 340 and the five-conductor flag 342 are turned off at the initial state. For example, the four-conductor flag 340 is made up of a one-bit register. When the four-conductor flag 340 is turned on (established), a data value “1” is set to the register. On the other hand, when the four-conductor flag 340 is turned off (not established), a data value “0” is set to the register. Moreover, the five-conductor flag 342 has the same configuration as the four-conductor flag 340, and therefore, the detailed description is omitted.

Although illustration is omitted, in the data memory area 304, address data including phone numbers and mail addresses of other mobile phone apparatuses, and a decoding result of the received voice signal are stored, and counters and flags necessary for operating the mobile phone apparatus 10 are also provided.

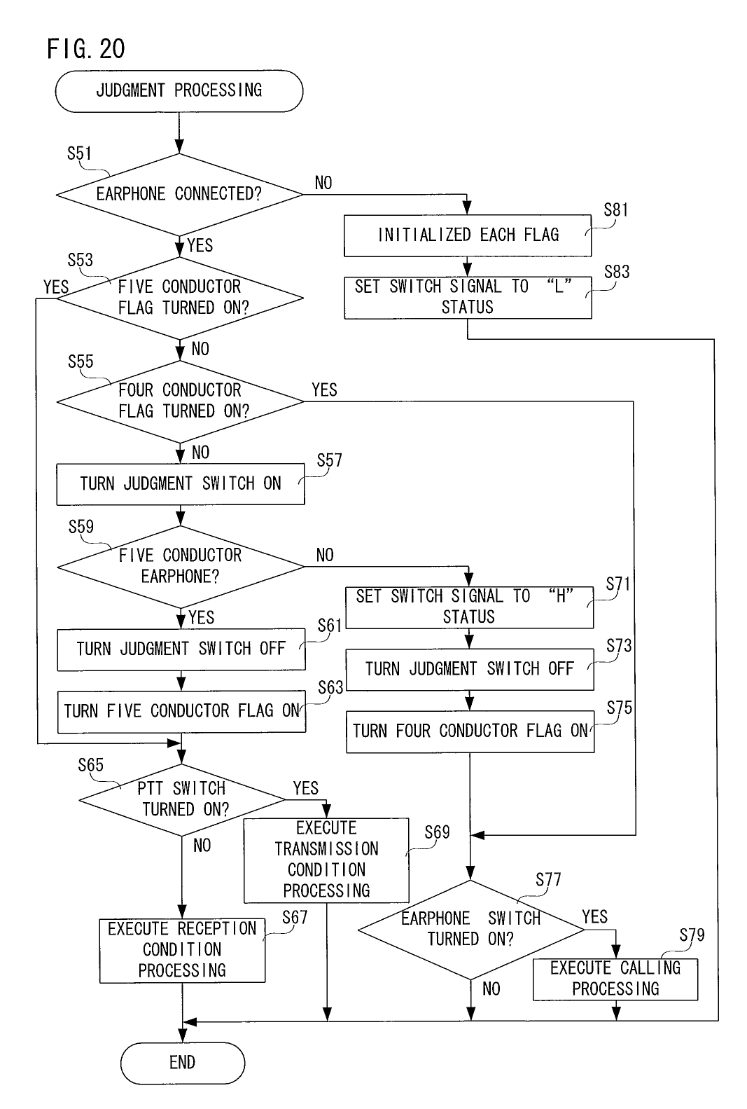

The processor 18 performs a plurality of tasks including a judgment program shown in FIG. 20 in parallel under the control of Linux (registered trademark)-based OSes such as Android (registered trademark), REX, etc. and other OSes.

FIG. 20 is a flowchart showing judgment processing. For example, when the mobile phone apparatus 10 is turned on, the processor 18 determines whether or not the earphone is connected in a step S51. That is, it is determined whether or not an insertion signal acquired from the sixth jack terminal is in the “L” status. If “NO” in the step S51, that is, if the earphone plug is not inserted, and the insertion signal is in the “H” status, the process proceeds to a step S81.

Alternatively, if “YES” is determined in the step S51, that is, if the four conductor or the five conductor earphone plug is inserted, and the insertion signal is in the “L” status, it is determined whether or not the five-conductor flag 342 is turned on in a step S53. That is, it is determined whether or not insertion of the five conductor earphone plug has already been judged. If “YES” in the step S53, that is, if the inserted earphone plug has been judged as a five conductor plug, the process proceeds to a step S65. On the other hand, if “NO” in the step S53, that is, if the inserted earphone plug has not been judged as the five conductor earphone plug, it is determined whether or not the four-conductor flag 340 is turned on in a step S55. That is, it is determined whether or not insertion of the four conductor earphone plug has already been judged. If “YES” is determined in the step S55, that is, if the inserted earphone plug has been judged as the four conductor plug, the process proceeds to a step S77.

On the other hand, if “NO” in the step S55, that is, if the number of conductors of the inserted earphone plug has not been judged, the processor 18 turns the judgment switch SW6 on in a step S57. That is, in order to judge whether the five conductor earphone plug or the four conductor earphone plug is inserted by the judgment signal, the voltage from the +B1 port of the power supply circuit 32 is applied to the third jack terminal. Here, the processor 18 executing the processing in the step S57 functions as a voltage applying unit.

Succeedingly, in a step S59, it is determined whether or not the five conductor earphone is inserted. That is, it is determined whether or not the judgment signal based on the voltage of the first jack terminal is in the “L” status. If “NO” in the step S59, that is, if the judgment signal is in the “H” status, the process proceeds to a step S71.

Furthermore, as shown in FIG. 18(B), if the voltage is applied to the first jack terminal, the judgment switch SW6 is turned off in a step S61. That is, the state of the judgment signal required for judgment is obtained, the judgment switch SW6 is turned off. Succeedingly, in a step S63, the five-conductor flag 342 is turned on. That is, since insertion of the five conductor earphone plug is judged, the five-conductor flag 342 is turned on. Here, the processor 18 executing the processing in the step S63 functions as a first judging unit.

Here, in the initial state, the analog switch 73 is switched so as to correspond to the arrangement of the terminals of the five conductor earphone plug, and thus, even if the inserted earphone plug is judged as a five conductor earphone plug, the state of the analog switch 73 remains as it is.

Succeedingly, in a step S65, it is determined whether or not the PTT switch is turned on. That is, it is determined whether or not the PTT switch signal acquired from the fifth jack terminal is in the “L” status. If “NO” in the step S65, if the user does not turn the PTT switch on, it is determined whether or not reception condition processing is executed in a step S67. When the reception condition processing is executed, it is determined whether or not an audio signal is received from another mobile phone apparatus, for example. Then, after completion of the reception condition processing, the judgment processing is also ended. On the other hand, if “YES” is determined in the step S65, that is, if the user turns the PTT switch on, for example, transmission condition processing is executed in a step S69. That is, the audio signal input to the microphone of the PTT earphone is transmitted to another mobile phone apparatus. Then, after completion of the transmission condition processing, the judgment processing is also ended.

Here, in another embodiment, while the PTT is not executed, the processing in the step S67 or the step S69 may be set not to be executed.

Additionally, when the four conductor earphone plug is inserted into the earphone jack 26, the state in FIG. 18(A) is brought about, and thus, the switching signal is set to the “H” state in the step S71. Thus, the two SPDT switches included in the analog switch 73 are simultaneously switched. Therefore, with respect to the SPDT switch which receives an input of the right audio signal, the port P1 (second jack terminal) to be connected with the right audio terminal of the four conductor earphone plug is connected to the port P5. Furthermore, with respect to the SPDT switch connected to the GND, the port P3 (first jack terminal) to be connected with the GND terminal of the four conductor earphone plug is connected to the port P8.

Succeedingly, in the step S73, similar to the step S61, the judgment switch SW6 is turned off. Then, in a step S75, the four-conductor flag 340 is turned on. That is, since insertion of the four conductor earphone plug is judged, the four conductor earphone flag 340 is turned on. Here, the processor 18 executing the processing in the step S75 functions as a second judging unit.

Succeedingly, in a step S77, it is determined whether or not the earphone switch is turned off. That is, it is determined whether or not the voltage value of the microphone signal stored in the earphone switch buffer 338 is above a threshold value. If “NO” in the step S77, that is, if the earphone switch is not turned on, and the voltage value of the microphone signal stored in the buffer is equal to or less than the threshold value, the judgment processing is ended. On the other hand, if “YES” is determined in the step S77, that is, if the earphone switch is turned on, and the voltage value of the microphone signal stored in the buffer is above the threshold value, calling processing is executed in a step S79 to end the judgment processing. For example, when the calling processing is executed in the standby condition, voice transmission processing is executed on the basis of an outgoing history. Furthermore, when the calling processing is executed during an incoming condition, the speech communication processing is executed after the communication capable state is established. In addition, when calling processing is executed during the speech communication, a speech communication end signal is transmitted to the communication partner to end the speech communication processing.

Furthermore, the judgment processing is repetitively executed every approximately 100 ms. Therefore, when the four or five conductor earphone plug is withdrawn from the earphone jack 26, “NO” is determined in the step S51, and each flag is initialized in the step S81. That is, the four-conductor flag 340 and the five-conductor flag 342 are turned off. Then, in a step S83, the switching signal is set to the “L” state, and the judgment processing is ended. That is, when the processing in the step S83 is executed, the two SPDT switches included in the analog switch 73 return to the state shown in FIG. 17.

Here, if the earphone plug is not inserted, “NO” is determined in the step S51 every execution of the judgment processing.

It should be noted that in the third embodiment, in the initial state, the analog switch 73 is switched so as to correspond to the arrangement of the terminals of the five conductor earphone plug, but in another embodiment, the arrangement of the terminals may be set so as to correspond to that of the four conductor earphone plug.

Furthermore, the communication system of the mobile phone apparatus 10 is according to the CDMA system, but an LTE (Long Term Evolution) system, a W-CDMA system, a GSM system, a TDMA system, an FDMA system and a PHS system may be adopted. In addition, an LCD monitor is employed as the display 24, but organic light emitting panels, etc. may be adopted.

Furthermore, the programs utilized in this embodiment may be stored in an HDD of a server for data delivery, and delivered to the mobile phone apparatus 10 via a network. Additionally, a plurality of programs are stored in a recording medium, such as an optical disk, such as CD, DVD, BD (Blu-ray Disc), etc., a USB memory, a memory card, or the like, and the recording medium may be sold or distributed. Then, in a case that the programs downloaded from the aforementioned server and recording medium are installed onto the mobile phone apparatus having the same configuration of the present embodiment, an advantage equal to the present embodiment can be obtained.

In addition, this embodiment may be applied to so-called smart phones, tablet typed PCs, portable musical players and PDAs, etc. without being restricted to only the mobile phone apparatus 10.

It should be noted that all the concrete numerical values depicted in the specification are all simple examples, and are changeable as necessary depending on the specification of the product.

This embodiment is a mobile terminal having a five conductor earphone jack used to be shared between a five conductor earphone plug provided with a left audio terminal, a right audio terminal and a GND terminal and a four conductor earphone plug provided with a left audio terminal provided at an equal position to the five conductor earphone and a GND terminal and a right audio terminal provided at positions opposite to those of the five conductor earphone plug, the five conductor earphone jack including a first terminal to be in contact with the right audio terminal of the five conductor earphone plug or the GND terminal of the four conductor earphone plug and a second terminal to be in contact with the left audio terminal, comprising: an outputter which outputs a test signal to the second terminal when the four conductor earphone plug or the five conductor earphone plug is inserted into the five conductor earphone jack, and an identifier which identifies which earphone plug is inserted, the five conductor earphone plug or the four conductor earphone plug depending on a detection of the test signal at the first terminal when the test signal is output from the outputter.

In this embodiment, a mobile terminal (10: reference numerals representing a corresponding part of this embodiment. This holds true hereafter.) having a five conductor earphone jack (26), etc. used to be shared between a five conductor earphone plug and a four conductor earphone plug. Furthermore, the five conductor earphone plug is provided with a left audio terminal, a right audio terminal and a GND terminal. On the other hand, the four conductor earphone plug is provided with the left audio terminal at an equal position to the five conductor earphone plug, and with the GND terminal and the right audio terminal at positions opposite to those of the five conductor earphone plug. Furthermore, the five conductor earphone jack includes a first terminal (first jack terminal) to be in contact with the right audio terminal of the five conductor earphone plug or the GND terminal of the four conductor earphone plug and a second terminal (third jack terminal) to be in contact with the left audio terminal. An outputter (18, 96, S57) is a DTMF generator, for example, and outputs a tone signal as a test signal. Then, when the four conductor or the five conductor earphone plug is inserted into the five conductor earphone jack, the outputter outputs a test signal to the second terminal. An identifier (18, 70, 75, S19-S25, S63, S75) identifies insertion of the four conductor earphone plug when the test signal is detected and insertion of the five conductor earphone plug when the test signal is not detected while the test signal is output.

According to this embodiment, since by utilizing the difference in the internal circuit between the four and five conductor earphones, insertion of these earphone plugs is identified, and therefore, it is possible to suitably use the earphones having a different number of terminals.

In addition, by decreasing the number of terminals provided to the earphone jack required for identification, it is possible to downsize the earphone jack.

Another embodiment is a mobile terminal further comprising a setter which sets a four conductor earphone mode when the identifier identifies insertion of the four conductor earphone plug.

In the other embodiment, when insertion of the four conductor earphone plug is identified, a setter (18, 70, S27) sets the four conductor earphone mode in order to outputting sound from the right and left earpieces of the four conductor earphone and maintain predetermined speech quality.

According to the other embodiment, in a case that four conductor earphones specific to the mobile phone apparatus that are available more on the market are used, the four conductor earphone mode is set to thereby prevent a volume difference between the right and left earpieces from occurring and degradation in the speech quality from due to echoes from occurring.

A still another embodiment is a mobile terminal, wherein the five conductor earphone jack further includes a third terminal which is in contact with the right audio terminal of the four conductor earphone plug and is grounded, right and left earpieces of a four conductor earphone are in series between the second terminal and the third terminal, and the second terminal to output sound is in contact with the left audio terminal of the four conductor earphone plug when the four conductor earphone plug is inserted into the five conductor earphone jack, further comprising a suspension controller which suspends sound output from the first terminal when the four conductor earphone mode is set, wherein a sound output from the second terminal is output from the right and left earpieces when the four conductor earphone mode is set.

In the still another embodiment, the five conductor earphone jack further includes a third terminal (second jack terminal) which is in contact with the right audio terminal of the four conductor earphone plug and is grounded. When the four conductor earphone plug is inserted, sound is set so as not to be output from the first terminal. Furthermore, while the four conductor earphone mode is set, the right and left earpieces of the four conductor earphone are in series between the second terminal to output sound and the grounded third terminal. In addition, the left audio terminal of the four conductor earphone plug is in contact with the second terminal of the five conductor earphone jack. A suspension controller (70, 84) suspends sound output from the first terminal when the four conductor earphone mode is set. Thus, when the four conductor earphone mode is set, the sound output from the second terminal is output from the right and left earpieces.

According to the still another embodiment, even if the four conductor earphone plug is inserted, it is possible to output sound from the right and left earpieces.

A further embodiment is a mobile terminal wherein the third terminal is further in contact with the GND terminal of the five conductor earphone plug, and the second terminal to output a left audio signal is in contact with the left audio terminal of the five conductor earphone plug, and the first terminal to output a right audio signal is in contact with the right audio terminal of the five conductor earphone plug when the five conductor earphone plug is inserted into the five conductor earphone jack.

In the further embodiment, the grounded third terminal is in contact with the GND terminal of the five conductor earphone plug. With the five conductor earphone plug inserted into the five conductor earphone jack, the second terminal to output a left audio signal is in contact with the left audio terminal of the five conductor earphone plug, and the first terminal to output a right audio signal is in contact with the right audio terminal of the five conductor earphone plug.

According to the further embodiment, in a case that insertion of the five conductor earphone is detected, the respective jack terminals of the earphone jack and the respective terminals of the five conductor earphone plug are connected with each other correctly (in one-to one correspondence) and therefore, it is possible to normally output sound.

Another embodiment is a mobile terminal wherein the four conductor earphone plug includes a microphone terminal, further comprising a transmitter/receiver circuit which transmits an audio signal acquired by a microphone connected to the microphone terminal, and an echo canceler which suppresses an echo of the audio signal transmitted by the transmitter/receiver circuit, wherein the echo canceler more suppresses an echo of the audio signal when the four conductor earphone mode is set in comparison with when the four conductor earphone mode is not set.

In the other embodiment, the four conductor earphone plug further includes a microphone terminal (50b). A transmitter/receiver circuit (72) transmits an audio signal acquired by a microphone to another mobile terminal, etc. An echo canceler (76) suppresses the echo included in the transmitted audio signal. Then, when a speech communication is made with the four conductor earphone plug having the microphone inserted, the received voice signal partner unintentionally flows through the microphone, resulting in an echo in the sending voice. Accordingly, the echo canceler more suppresses an echo of the audio signal when the four conductor earphone mode is set in comparison with when the four conductor earphone mode is not set.

According to the other embodiment, in a case that the four conductor earphone is used, a double talk performance slightly deteriorates due to the echo canceler, but it is possible to maintain the predetermined speech quality.

A still another embodiment is a mobile terminal, wherein the five conductor earphone jack further comprises a third terminal which is to be in contact with the GND terminal of the five conductor earphone plug or the right audio terminal of the four conductor earphone plug, and further comprising a switcher which makes a switch to a position causing the right audio signal to be output to the first terminal, and causing the third terminal to be grounded when the identifier identifies insertion of the five conductor earphone plug, and makes a switch to a position causing the first terminal to be grounded and causing the right audio signal to be output to the third terminal when the identifier identifies insertion of the four conductor earphone plug.

In the still another embodiment, the third terminal (second jack terminal) is in contact with the GND terminal of the five conductor earphone plug or the right audio terminal of the four conductor earphone plug. For example, a switcher (73) includes an analog switch. Then, when insertion of the five conductor earphone plug is judged, a switch to a position causing the right audio signal to be output to the first terminal, and causing the third terminal to be grounded is made. On the other hand, when insertion of the four conductor earphone plug is judged, a switch to a position causing the first terminal to be grounded and causing the right audio signal to be output to the third terminal is made when the identifier identifies insertion of the four conductor earphone plug is made.

According to the still another embodiment, on the basis of the identification result, the terminal to which the right sound is output is switched. Thus, even if the four conductor earphone plug is inserted, it is possible to output stereo sound from the earphones.

A further embodiment is a mobile terminal further comprising an executor which executes stand-by processing when the four conductor earphone plug or the five conductor earphone plug is inserted into the five conductor earphone jack, and the outputter outputs a test signal to the second terminal after completion of the stand-by processing.

In the further embodiment, an executor (18, 70, S11) executes stand-by processing for a predetermined time (500 ms, for example) when either one of the earphone plug is inserted into the five conductor earphone jack. That is, the test signal is output a predetermined time after the insertion of the earphone plug.

According to the further embodiment, it is possible to prevent incorrect identification when the earphone plug is slowly inserted into the earphone jack.

Another embodiment is a mobile terminal further comprising an amplifier which amplifies the test signal detected at the first terminal as a pulse signal, and the identifier identifies insertion of the four conductor earphone plug into the five conductor earphone jack when a change in the pulse signal is detected more than a predetermined number of times.

In the other embodiment, an amplifier (110, 112) amplifies the test signal being a sine wave, for example, into a pulse signal. Then, when a change in the pulse signal is detected more than a predetermined number of times, the identifier identifies insertion of the four conductor earphone plug.

According to the other embodiment, the changes of the pulse signal is utilized to exhibit hysteresis, so that it is possible to prevent incorrect identification when the earphone plug is slowly inserted.

A still another embodiment is a mobile terminal, wherein the five conductor earphone plug includes a microphone terminal, and the five conductor earphone jack includes a fourth terminal which is to be in contact with the microphone terminal, further comprising a power source controller which applies a voltage bias to the fourth terminal, and a voltage controller which turns the voltage bias applied to the fourth terminal off when the four conductor earphone plug or the five conductor earphone plug is inserted into the five conductor earphone jack.

In the still another embodiment, the five conductor earphone plug also includes a microphone terminal similar to the four conductor earphone plug. The five conductor earphone jack includes a fourth terminal (fourth jack terminal) which is to be in contact with the microphone terminal. A power source controller (32) applies a voltage bias (microphone bias) to the fourth terminal that is connected to the microphone of the five conductor earphone. Then, when the earphone plug is inserted into the five conductor earphone jack, a voltage controller (18, S9) turns off the voltage bias applied to the fourth terminal.

According to the still another embodiment, impedance of the earphone microphone is high, and therefore, it is possible to reduce leakage of the test signal unintentionally flowing through the earphone microphone. Accordingly, it is possible to prevent incorrect identification when the earphone plug is slowly inserted into the five conductor earphone jack.

A further embodiment is a mobile terminal, wherein the five conductor earphone jack further includes a third terminal which is to be in contact with the GND terminal of the five conductor earphone plug or the right audio terminal of the four conductor earphone plug, the outputter includes a voltage applier which applies a voltage to the second terminal when the earphone plug is inserted into the earphone jack, and the identifier includes a detector which detects a voltage of the first terminal when the voltage is applied by the voltage applier, a first judger which judges that the five conductor earphone plug is inserted into the earphone jack when the detector detects no voltage after the voltage is applied, and a second judger which judges that the four conductor earphone plug is inserted into the earphone jack when the detector detects a voltage after the voltage is applied.

In the further embodiment, the third terminal (second jack terminal) is in contact with of the GND terminal of the five conductor earphone plug or the right audio terminal of the four conductor earphone plug. A voltage applier (18, S57) applies a voltage by turning on the switch (SW6) provided external to the earphone jack when the earphone plug is inserted into the earphone jack. A detector (75) detects a voltage applied to the first terminal through the internal circuit of the earphone when a voltage is applied to the second terminal. A first judger (18, S63) judges that the five conductor earphone plug is inserted when the detector detects no voltage after the voltage is applied. On the other hand, a second judger (18, S75) judges that the four conductor earphone plug is inserted when the detector detects a voltage after the voltage is applied.

Another embodiment is a mobile terminal further comprising a switcher (73) which makes a switch to a position causing the right audio signal to be output to the first terminal and causing the third terminal to be grounded when the first judger judges that the five conductor earphone plug is inserted, and makes a switch to a position causing the first terminal to be grounded and causing the right audio signal to be output to the third terminal when the second judger judges that the four conductor earphone plug is inserted.

In the other embodiment, a switcher (73) includes two switches. Then, when insertion of the five conductor earphone plug is judged, the respective switches make switches to positions causing the right audio signal to be output to the first terminal and causing the third terminal to be grounded. On the other hand, when insertion of the four conductor earphone plug is judged, the respective switches make switches to positions causing the first terminal to be grounded and causing the right audio signal to be output to the third terminal.

According to the further embodiment and the other embodiment, by utilizing the difference in the internal circuit of the earphone, whether the five conductor earphone plug or the four conductor earphone plug is inserted can be judged. Thus, by decreasing the number of jack terminals required for judgment, it is possible to downsize the earphone jack.

A still another embodiment is an earphone identifying method of a mobile terminal (10) having a five conductor earphone jack (26) used to be shared between a five conductor earphone plug provided with a left audio terminal, a right audio terminal and a GND terminal and a four conductor earphone plug provided with a left audio terminal provided at an equal position to the five conductor earphone and a GND terminal and a right audio terminal provided at positions opposite to those of the five conductor earphone plug, the five conductor earphone jack including a first terminal (first jack terminal) to be in contact with the right audio terminal of the five conductor earphone plug or the GND terminal of the four conductor earphone plug and a second terminal (third jack terminal) to be in contact with the left audio terminal, and including an outputter (96) outputting a test signal to the second terminal when the four conductor earphone plug or the five conductor earphone plug is inserted into the five conductor earphone jack, comprising identifying which is inserted, the five conductor earphone plug or the four conductor earphone plug depending on a detection of the test signal at the first terminal when the test signal is output from the outputter (S19-S25).

According to the still another embodiment, since by utilizing the difference in the internal circuit between the four and five conductor earphones, insertion of these earphone plugs is identified, and therefore, it is possible to suitably use the earphones having a different number of terminals.

A further embodiment is a mobile terminal having an earphone jack used to be shared between a four conductor earphone plug provided with a left audio terminal, a right audio terminal and a GND terminal and a five conductor earphone plug provided with a left audio terminal provided at an equal position to the four conductor earphone plug and a GND terminal and a right audio terminal provided at positions opposite to those of the four conductor earphone plug, the earphone jack including a first terminal to be in contact with the left audio terminal, a second terminal to be in contact with the GND terminal of the five conductor earphone plug or the right audio terminal of the four conductor earphone plug, and a third terminal to be in contact with the right audio terminal of the five conductor earphone plug or the GND terminal of the four conductor earphone plug, comprising: a voltage applier which applies a voltage to the first terminal when the earphone plug is inserted into the earphone jack; a detector which detects a voltage of the third terminal when the voltage applier applies the voltage; a first judger which judges that the five conductor earphone plug is inserted into the earphone jack when the detector detects no voltage after the voltage is applied; a second judger which judges that the four conductor earphone plug is inserted into the earphone jack when the detector detects a voltage after the voltage is applied; and a switcher which makes a switch to a position causing the right audio signal to be output to the third terminal and causing the second terminal to be grounded when the first judger judges that the five conductor earphone plug is inserted, and makes a switch to a position causing the third terminal to be grounded and causing the right audio signal to be output to the second terminal when the second judger judges that the four conductor earphone plug is inserted.

In the further embodiment, a mobile terminal (10) includes an earphone jack (26) used to be shared between a four conductor earphone plug and a five conductor earphone plug. Also, the four conductor earphone plug and the five conductor earphone plug are provided with a left audio terminal (52), a right audio terminal (56), a GND terminal (54), etc., but the right audio terminal (56) and the GND terminal (54) are provided at opposite positions between these plugs. Furthermore, a first terminal (third jack terminal) of the earphone jack is in contact with the left audio terminal of the earphone plug, and a second terminal (second jack terminal) and a third terminal (first jack terminal) are in contact with the GND terminals or the right audio terminals of the four and five conductor earphone plugs. A voltage applier (18, S57) applies a voltage to the first terminal by turning on a switch (SW6) provided external to the earphone jack when the earphone plug is inserted into the earphone jack. A detector (75) detects a voltage applied to the third terminal through the internal circuit of the earphone when a voltage is applied to the first terminal. A first judger (18, S63) judges that the five conductor earphone plug is inserted when the detector detects no voltage. On the other hand, a second judger (18, S75) judges that the four conductor earphone plug is inserted when the detector detects a voltage. For example, a switcher (73) includes two SPDT switches. Then, when insertion of the five conductor earphone plug is judged, the respective SPDT switches make switches to positions causing the right audio signal to be output to the third terminal and causing the second terminal to be grounded. On the other hand, when insertion of the four conductor earphone plug is judged, the respective SPDT switches make switches to positions causing the third terminal to be grounded and causing the right audio signal to be output to the second terminal.

According to the further embodiment, by utilizing the difference in the internal circuit of the earphones, whether the five conductor earphone plug or the four conductor earphone plugs is inserted can be judged. Thus, by decreasing the number of jack terminals required for judgment, it is possible to downsize the earphone jack.

Another embodiment is a mobile terminal (10) to which a first earphone plug (five conductor earphone plug) and a second earphone plug (four conductor earphone plug) provided with GND terminals and first audio terminals at opposite positions between them can be inserted, comprising a measure (75) which measures a voltage of a jack of the first audio terminal when the first earphone plug and the second earphone plug are inserted; and a switcher (73) which switches between the GND terminal and a signal to be output to the first audio terminal on the basis of a result of the measurement by the measure.

According to the other embodiment, by utilizing the difference in the internal circuit of the earphones, whether the five conductor earphone plug or the four conductor earphone plugs is inserted can be judged. Thus, by decreasing the number of jack terminals required for judgment, it is possible to downsize the earphone jack.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mobile terminal having a five conductor earphone jack used to be shared between a five conductor earphone plug provided with a left audio terminal, a right audio terminal and a GND terminal and a four conductor earphone plug provided with a left audio terminal provided at an equal position to said five conductor earphone and a GND terminal and a right audio terminal provided at positions opposite to those of said five conductor earphone plug, said five conductor earphone jack including a first terminal to be in contact with said right audio terminal of said five conductor earphone plug or said GND terminal of said four conductor earphone plug and a second terminal to be in contact with said left audio terminal, comprising:
an outputter which outputs a test signal to said second terminal when said four conductor earphone plug or said five conductor earphone plug is inserted into said five conductor earphone jack, and
an identifier which identifies which earphone plug is inserted, said five conductor earphone plug or said four conductor earphone plug depending on a detection of the test signal by said first terminal when the test signal is output from said outputter.

2. A mobile terminal according to claim 1, further comprising a setter which sets a four conductor earphone mode when said identifier identifies insertion of said four conductor earphone plug.

3. A mobile terminal according to claim 2, wherein said five conductor earphone jack further includes a third terminal which is in contact with said right audio terminal of said four conductor earphone plug and is grounded,
right and left earpieces of a four conductor earphone are in series between said second terminal and said third terminal, and said second terminal to output sound is in contact with the left audio terminal of said four conductor earphone plug when said four conductor earphone plug is inserted into said five conductor earphone jack, further comprising
a suspension controller which suspends sound output from said first terminal when said four conductor earphone mode is set, wherein
a sound output from said second terminal is output from said right and left earpieces when said four conductor earphone mode is set.

4. A mobile terminal according to claim 3, wherein said third terminal is further in contact with said GND terminal of said five conductor earphone plug, and
said second terminal to output a left audio signal is in contact with said left audio terminal of said five conductor earphone plug, and said first terminal to output a right audio signal is in contact with said right audio terminal of said five conductor earphone plug when said five conductor earphone plug is inserted into said five conductor earphone jack.

5. A mobile terminal according to claim 2, wherein said four conductor earphone plug includes a microphone terminal, further comprising
a transmitter/receiver circuit which transmits an audio signal acquired by a microphone connected to said microphone terminal, and
an echo canceler which suppresses an echo of the audio signal transmitted by said transmitter/receiver circuit, wherein
said echo canceler more suppresses an echo of said audio signal when said four conductor earphone mode is set in comparison with when said four conductor earphone mode is not set.

6. A mobile terminal according to claim 1, wherein said five conductor earphone jack further comprises a third terminal which is to be in contact with said GND terminal of said five conductor earphone plug or said right audio terminal of said four conductor earphone plug, and further comprising
a switcher which makes a switch to a position causing the right audio signal to be output to said first terminal, and causing said third terminal to be grounded when said identifier identifies insertion of said five conductor earphone plug, and makes a switch to a position causing said first terminal to be grounded and causing the right audio signal to be output to said third terminal when said identifier identifies insertion of said four conductor earphone plug.

7. A mobile terminal according to claim 1, further comprising an executor which executes stand-by processing when said four conductor earphone plug or said five conductor earphone plug is inserted into said five conductor earphone jack, and
said outputter outputs a test signal to said second terminal after completion of said stand-by processing.

8. A mobile terminal according to claim 1, further comprising an amplifier which amplifies the test signal detected by said first terminal as a pulse signal, and
said identifier identifies insertion of said four conductor earphone plug into said five conductor earphone jack when a change in said pulse signal is detected more than a predetermined number of times.

9. A mobile terminal according to claim 1, wherein said five conductor earphone plug includes a microphone terminal, and
said five conductor earphone jack includes a fourth terminal which is to be in contact with said microphone terminal, further comprising
a power source controller which applies a voltage bias to said fourth terminal, and
a voltage controller which turns the voltage bias applied to said fourth terminal off when said four conductor earphone plug or said five conductor earphone plug is inserted into said five conductor earphone jack.

10. A mobile terminal according to claim 1, wherein said five conductor earphone jack further includes a third terminal which is to be in contact with said GND terminal of said five conductor earphone plug or said right audio terminal of said four conductor earphone plug,
said outputter includes a voltage applier which applies a voltage to said second terminal when said earphone plug is inserted into said earphone jack, and
said identifier includes a detector which detects a voltage of said first terminal when the voltage is applied by said voltage applier, a first judger which judges that said five conductor earphone plug is inserted into said earphone jack when said detector detects no voltage after the voltage is applied, and a second judger which judges that said four conductor earphone plug is inserted into said earphone jack when said detector detects a voltage after the voltage is applied.

11. A mobile terminal according to claim 10, further comprising a switcher which makes a switch to positions causing the right audio signal to be output to said first terminal and causing said third terminal to be grounded when said first judger judges that said five conductor earphone plug is inserted, and makes a switch to positions causing said first terminal to be grounded and causing the right audio signal to be output to said third terminal when said second judger judges that said four conductor earphone plug is inserted.

12. An earphone identifying method of a mobile terminal having a five conductor earphone jack used to be shared between a five conductor earphone plug provided with a left audio terminal, a right audio terminal and a GND terminal and a four conductor earphone plug provided with a left audio terminal provided at an equal position to said five conductor earphone and a GND terminal and a right audio terminal provided at positions opposite to those of said five conductor earphone plug, said five conductor earphone jack including a first terminal to be in contact with said right audio terminal of said five conductor earphone plug or said GND terminal of said four conductor earphone plug and a second terminal to be in contact with said left audio terminal, and including an outputter outputting a test signal to said second terminal when said four conductor earphone plug or said five conductor earphone plug is inserted into said five conductor earphone jack, comprising
identifying which is inserted, said five conductor earphone plug or said four conductor earphone plug in response to a detection of the test signal by said first terminal when the test signal is output from said outputter.

13. A mobile terminal having an earphone jack used to be shared between a four conductor earphone plug provided with a left audio terminal, a right audio terminal and a GND terminal and a five conductor earphone plug provided with a left audio terminal provided at an equal position to said four conductor earphone and a GND terminal and a right audio terminal provided at positions opposite to those of said four conductor earphone plug, said earphone jack including a first terminal to be in contact with said left audio terminal, a second terminal to be in contact with said GND terminal of said five conductor earphone plug or said right audio terminal of said four conductor earphone plug, and a third terminal to be in contact with said right audio terminal of said five conductor earphone plug or said GND terminal of said four conductor earphone plug, comprising:
a voltage applier which applies a voltage to said first terminal when said earphone plug is inserted into said earphone jack;
a detector which detects a voltage of said third terminal when said voltage applier applies the voltage;
a first judger which judges that said five conductor earphone plug is inserted into said earphone jack when said detector detects no voltage after the voltage is applied;
a second judger which judges that said four conductor earphone plug is inserted into said earphone jack when said detector detects a voltage after the voltage is applied; and
a switcher which makes a switch to positions causing the right audio signal to be output to said third terminal and causing said second terminal to be grounded when said first judger judges that said five conductor earphone plug is inserted, and makes a switch to positions causing said third terminal to be grounded and causing the right audio signal to be output to said second terminal when said second judger judges that said four conductor earphone plug is inserted.

14. A mobile terminal to which a first earphone plug and a second earphone plug provided with GND terminals and first audio terminals at opposite positions between them can be inserted, comprising
a measure which measures a voltage of a jack of said first audio terminal when said first earphone plug and said second earphone plug are inserted; and
a switcher which switches between said GND terminal and a signal to be output to said first audio terminal on the basis of a result of the measurement by said measure.
